(19) United States
(12) Patent Application Publication
(10) Pub. No.: US 2024/0078484 A1
(43) Pub. Date: Mar. 7, 2024

(54) GENERATING AND PROVIDING AN ACCOUNT PRIORITIZATION SCORE BY INTEGRATING EXPERIENCE DATA AND ORGANIZATION DATA

(71) Applicant: Qualtrics, LLC, Provo, UT (US)

(72) Inventors: Grzegorz Kolano, Cracow (PL); Anderson Quach, Seattle, WA (US); Manisha Powar, Seattle, WA (US); Daniel Bargiel, Niepolomice (PL)

(21) Appl. No.: 17/929,596

(22) Filed: Sep. 2, 2022

(51) Int. Cl. G06Q 10/06; G06Q 30/02

(52) U.S. Cl. CPC G06Q 10/06315; G06Q 10/06312; G06Q 30/0201; G06Q 30/0203

(57) ABSTRACT

The present disclosure relates to systems, non-transitory computer-readable media, and methods for generating account prioritization scores for various accounts based on experience data and organization data and providing visual representations of the account prioritization scores via a graphical user interface. In particular, in one or more embodiments, the disclosed systems organize experience data and organization data to utilize in generating the account prioritization score. Further, in some embodiments, the disclosed systems generate and provide an explanation of a key factor for the account prioritization score. Thus, the disclosed systems provide an accurate and efficient graphical user interface to enable quick comprehension of even very large datasets corresponding to various accounts.

### BACKGROUND

Recent years have seen significant improvements in the collection and storage of large amounts of data. For example, various businesses use digital survey systems to collect information from their customers to attempt to understand how to improve products and services. Due to the prevalence of digital communications, digital survey systems can now collect large amounts of data from thousands or even millions of users. While there have been improvements in the collection and storage techniques of large amounts of data, conventional systems often fail to fully realize the insights that can be gained from large datasets due to the inability to provide users an efficient and effective way to interact with and understand the large datasets associated with large numbers of accounts.

For instance, many conventional systems are inaccurate in various recommendations due to their management of various large datasets. To illustrate, conventional systems often silo data gathered from third-party systems separately from one another and separately from first-party data. Thus, it is inefficient or even impossible to utilize this disparate data in tandem with one another. Indeed, for many conventional systems, the incompatibility of data from different systems prohibits utilization of the data together to make any sort of determination.

Further, the incompatibility of data across different systems can cause inaccurate decision-making for conventional systems. To illustrate, such large quantities of data are inefficient to navigate and visualize. Indeed, many conventional systems provide data reporting interfaces that are inefficient because they are difficult to navigate and understand. Because many conventional systems silo datasets across disparate systems, these conventional systems require navigation of a variety of different graphical user interfaces to access various data. Additionally, many conventional systems provide graphical user interfaces that require a large number of user interactions to parse through data. To illustrate, conventional systems may require numerous different selections and interactions in a time-consuming multiple-layer graphical interface process within a report builder interface to define parameters for even a single report. This inefficiency also expends undue time and computing resources.

In addition, many conventional systems lack flexibility in providing recommendations for accounts that correspond to various datasets. This problem is compounded in conventional systems due to incompatibility of data across different systems. Accordingly, many conventional systems are limited in account recommendations to data from a single system or dataset. Further, the recommendations of many conventional systems are rigid and inflexible due to limited criteria that may be considered. Thus, the recommendations of many conventional systems are inapplicable in a variety of contexts.

These along with additional problems and issues exist with regard to conventional systems.

### BRIEF SUMMARY

Embodiments of the present disclosure provide benefits and/or solve one or more of the foregoing or other problems in the art with systems, non-transitory computer-readable media, and methods for generating and providing an account prioritization score, an explanation of key factors, and a priority category utilizing data from across disparate systems, including experience data and organization data. To illustrate, in one or more embodiments, the disclosed systems utilize both experience data corresponding to various facets of customer experience with an account and organization data corresponding to operational metrics of the account. In one or more embodiments, the disclosed systems utilize both experience data and organization data by integrating disparate data from different systems into a unified database. Thus, the disclosed systems can generate an account prioritization score that reflects a variety of information, including utilizing data from disparate and previously incompatible systems.

Additional features and advantages of one or more embodiments of the present disclosure are outlined in the description which follows, and in part will be obvious from the description, or may be learned by the practice of such example embodiments.

### BRIEF DESCRIPTION OF THE DRAWINGS

The detailed description provides one or more embodiments with additional specificity and detail through the use of the accompanying drawings, as briefly described below.

FIG. 1 illustrates a diagram of an environment in which an account prioritization system can operate in accordance with one or more embodiments.

FIG. 2 illustrates an example graphical user interface for providing account prioritization summaries including account prioritization scores in accordance with one or more embodiments.

FIG. 3 illustrates an example process for utilizing experience data and organization data to generate an account prioritization score in accordance with one or more embodiments.

FIG. 4 illustrates an example process for integrating experience data and organization data into a unified database in accordance with one or more embodiments.

FIG. 5 illustrates an example graphical user interface for defining parameters for an account prioritization score in accordance with one or more embodiments.

FIG. 6 illustrates an example graphical user interface for selecting defined parameters for an account prioritization score in accordance with one or more embodiments.

FIG. 7 illustrates example process for determining a key factor and providing an explanation of a key factor in accordance with one or more embodiments.

FIGS. 8A-8D illustrate example account prioritization graphical user interfaces in accordance with one or more embodiments.

FIG. 9 illustrates a flowchart of a series of acts for generating an and providing an account prioritization score in accordance with one or more embodiments.

FIG. 10 illustrates a block diagram of an example computing device for implementing one or more embodiments of the present disclosure.

FIG. 11 illustrates a network environment of a digital survey system in accordance with one or more embodiments.

### DETAILED DESCRIPTION

This disclosure describes one or more embodiments of an account prioritization system that generates and provides a multi-faceted account prioritization score utilizing organization data and experience data and providing visualizations of the prioritization score via a graphical user interface. More specifically, the account prioritization system integrates and organizes data from various sources in order to utilize various data types to determine the account prioritization score. In addition, in one or more embodiments, the account prioritization system determines a key factor for the account prioritization score from experience data and organization data. Further, in some embodiments, the account prioritization system generates an explanation of the key factor and provides the explanation in the graphical user interface. Thus, the account prioritization system provides intuitive and accurate visualizations of information from disparate systems.

As mentioned, the account prioritization system generates an account prioritization score based on experience data and organization data. More specifically, in one or more embodiments, the account prioritization system generates an account prioritization score based on experience data and organization data. In some embodiments, the account prioritization system determines the account prioritization score based on administrator-selected criteria from experience data and organization data. Additionally, in one or more embodiments, the account prioritization system provides various account prioritization scores in a graphical user interface.

In one or more embodiments, the account prioritization system generates account prioritization scores utilizing experience data including various experience data metrics. For example, the account prioritization system can utilize a net promoter score reflecting customer loyalty to an account. In addition, in some embodiments, the account prioritization system utilizes a customer satisfaction score reflecting a proportion of customers satisfied with their experience corresponding to an account. Further, in one or more embodiments, the account prioritization system utilizes a customer experience score reflecting a proportion and degree of positive experiences that customers have with a user account, including personalization of experience. Additionally, in some embodiments, the account prioritization system utilizes a customer relationship management score for an account that reflects customer experience across various types and times of user experiences.

As mentioned above, the account prioritization system also utilizes organization data to generate account prioritization scores. In one or more embodiments, the organization data includes operational metrics for accounts. To illustrate, organization data can include account size, operating margin, an urgency score, and other operational metrics. In some embodiments, the account prioritization system utilizes organization data to determine a scale for importance or urgency corresponding to an account. The account prioritization system can communicate this urgency or scale both in an account prioritization score and in a visualization of an account prioritization score.

In one or more embodiments, the account prioritization system generates visualizations of account prioritization scores to provide intuitive and efficient indications of priority within a graphical user interface. To illustrate, in one or more embodiments, the account prioritization system generates a graphical user interface element or graphic that utilizes size, color, placement, etc. to communicate the state, scope, and/or urgency of a user account at a glance.

In one or more embodiments, the account prioritization system integrates experience data and organization data from different systems. More specifically, in some embodiments, the account prioritization system reformats experience data and organization data in order to organize the data into a unified database. In one or more embodiments, the account prioritization system utilizes timestamp data from various systems to integrate the organization data and the experience data into the unified database.

In some embodiments, the account prioritization system determines the account prioritization score based on a formula and/or criteria selected via an administrator device. To illustrate, in one or more embodiments, the account prioritization system provides a graphical user interface for customizing particular criteria, metrics, and categorizations for an account prioritization score. In addition, or in the alternative, the account prioritization system can provide a graphical user interface for selecting from pre-configured account prioritization score formulas. In one or more embodiments, the account prioritization system generates priority categories based on score ranges set via an administrator device.

As mentioned above, in one or more embodiments, the account prioritization system determines key factors based on account prioritization scores. To illustrate, the account prioritization system can determine the key factor by identifying a primary contributing factor to an account prioritization score and/or its corresponding priority category. In addition, or in the alternative, the account prioritization system can determine the key factor by identifying a factor or metric most contributing to a change in the account prioritization score, as will be described in detail below.

The account prioritization system provides many advantages and benefits over conventional systems and methods. For example, by integrating disparate data (experience data and operational data) from various different systems into a single unified database, the account prioritization system improves accuracy and efficiency relative to conventional systems, and well creates data analysis not previously possible in conventional systems. To illustrate, in one or more embodiments, the account prioritization system reformats various data from different systems and integrates the data into a single unified database utilizing timestamp data. Accordingly, in one or more embodiments, the account prioritization system is able to utilize a variety of data to determine a single account prioritization score that would not be able to be utilized together by conventional systems. Thus, the account prioritization system improves accuracy of prioritization recommendations over conventional systems by integrating the disparate data.

Further, by integrating the data into a single unified database, the account prioritization system improves the efficiency of graphical user interfaces providing and utilizing the data from the unified database. To illustrate, the account prioritization system provides account prioritization scores, priority categories, and explanations of key factors in a single graphical user interface so that an abundance of information from a variety of different systems is apparent at a glance. This reduces or eliminates excess user interactions required by graphical user interfaces of conventional systems in order to locate the same information across different systems. Additionally, this efficiency reduces or eliminates excess time, navigational steps, and computing resources utilized by conventional systems in managing and navigating disparate systems.

The account prioritization system also improves flexibility relative to conventional systems by providing a customizable and multi-faceted account prioritization score. To illustrate, the account prioritization system provides various account prioritization scores that are applicable in a wide variety of contexts by determining account prioritization scores based on administrator settings. To illustrate, the account prioritization system can generate and provide a graphical user interface for customizing metrics, weights, and other criteria for an account prioritization score. Additionally, the account prioritization system can provide a graphical user interface for customizing priority categories, including based on account prioritization scores and various contributing metrics. Because the account prioritization system integrates data from a variety of systems, it is able to include a wide variety of options for metrics and criteria for account prioritization scores. Thus, the account prioritization system provides account prioritization scores that are relevant to criteria for a wide variety of contexts and use cases. Accordingly, the account prioritization system provides increased flexibility relative to conventional systems.

As illustrated by the foregoing discussion, the present disclosure utilizes a variety of terms to describe features and advantages of the account prioritization system. Additional detail is now provided regarding the meaning of such terms. For example, as used herein, the term “account prioritization score” refers to a score reflecting precedence, health, and/or urgency corresponding to an account. In particular, the term “account prioritization score” can include a score determined based on a variety and combination of organization data and experience data, including from disparate systems. To illustrate, an account prioritization score can include a numerical score that reflects both organization data and experience data weighted according to system generated factors and/or administrator selections.

Additionally, as used herein, the term “account” refers to a record of information associated with an entity (e.g., organization or individual). In particular, the term “account” can include an arrangement with an organization in which the account prioritization system provides customer experience services to an organization, which can include, for example, digital survey services. To illustrate, an account can include an organization that an account prioritization system maintains a relationship with and/or information corresponding to that organization. An account can also include information received from third-party services corresponding to the organization.

Further, as used herein, the term “experience data” refers to data reflecting user or customer experiences associated with an account. In particular, the term “experience data” can include experience data metrics that reflect various customer experiences and/or sentiments. The term experience data can also include non-numerical measures of customer experiences. To illustrate, experience data can include a net promoter score that reflects or quantifies customer loyalty to an account, electronic survey responses, social media information, as well as additional experience data.

Additionally, experience data can include a summary of experience data, for example, a customer satisfaction score that corresponds to or quantifies a proportion of customers satisfied with their experience corresponding to an account. Further, experience data can include a customer experience score that reflects or quantifies a proportion and/or degree of positive or negative experiences that customers have with an organization, including with customer personalization. Also, experience data can include a customer relationship management score for an account that reflects customer experience across various types of experiences and instances of user experiences. A customer experience score can quantify or reflect more specific records of specific customer experiences at various touchpoints in a customer journey.

Also, as used herein, the term “organization data” refers to data reflecting attributes of an entity associated with an account. In particular, the term “organization data” can include a variety of operating metrics that reflect the size, importance, or urgency of an organization corresponding to an account at a particular point in time. To illustrate, organization data can include account size in customer base, user base, revenue, profit, expenses, or other metrics. Additionally, organization data can include operating margins for the account. Further, organization data can include an urgency score for the account that reflects calendar data or deadline data corresponding to an organization for an account.

Additionally, as used herein, the term “key factor” refers to an important metric, statistic, or criterion. To illustrate, a key factor can include a type of data, a set of data, and/or a weight of data that contributes to a score or metric. A key factor can include a type of data that most contributes to the account prioritization score. Additionally, a key factor can include a type of data that most contributes to a change in the account prioritization score.

Further, as used herein, the term “visualization” refers to a visual representation of information or data. In particular, the term “visualization” can include a graphic, chart, graph, or other formation of data, a score, or a metric. To illustrate, a visualization can include a chart or graphic that utilizes color, size, shape, position, etc. to show various facets of a score or metric, including an account prioritization score.

Also, as used herein, the term “priority category” refers to a grouping based on precedence, health. In particular, the term “priority category” can include groupings based on particular criteria or metrics or based on numerical categories for an overall metric or score. To illustrate, a priority category can include a group of accounts based on overall health, priority, or urgency. For example, priority categories might include categorizations for good, average, poor, opportunity for growth, or emergency.

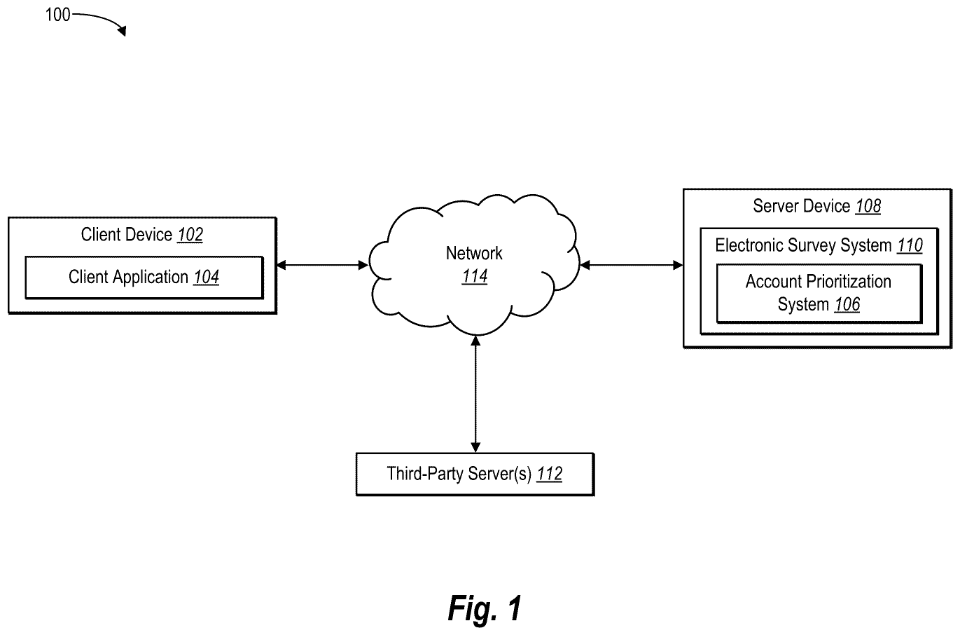

Additional features and characteristics of one or more embodiments of the system are described below with respect to the Figures. For example, FIG. 1 illustrates a block diagram of an example embodiment of a system 100. In general, and as illustrated in FIG. 1, the system 100 includes a client device 102 including a client application 104. The client device 102 communicates with server device(s) 108, including an electronic survey system 110 and an account prioritization system 106, over a network 114. Further, the system 100 includes third-party server(s) 112 that may also communicate with the client device 102 and/or the server device(s) 108 via the network 114.

As will be described in greater detail below, the client device 102 can perform or provide the various functions, features, processes, methods, and systems as described herein. Additionally, or alternatively, the server device(s) 108 can perform or provide the various functions, features, processes, methods and systems as described herein. In one or more embodiments, the client device 102 and server device(s) 108 coordinate together to perform or provide the various functions, features, processes, methods, and systems, as described in more detail below.

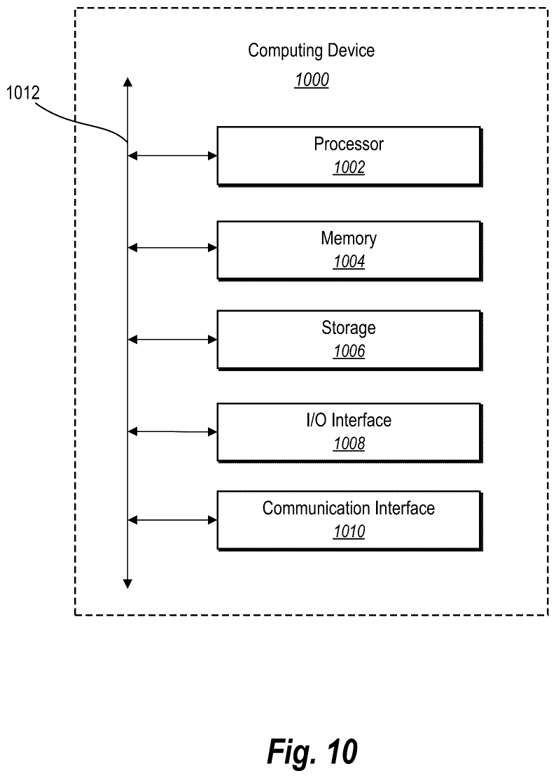

Generally, the client device 102 can include any one of various types of client devices. For example, the client device 102 can be a mobile device (e.g., a smart phone), tablet, laptop computer, desktop computer, or any other type of computing device as further explained below with reference to FIG. 10. Additionally, the client application 104 can include any one of various types of client applications. For example, the client application 104 can be a web browser, and a user at the client device 102 may enter a Uniform Resource Locator (URL) or other address directing the web browser to access the account prioritization system 106 and/or the electronic survey system 110 on the server device(s) 108. Alternatively, the client application can be a native application installed and executed on the client device 102.

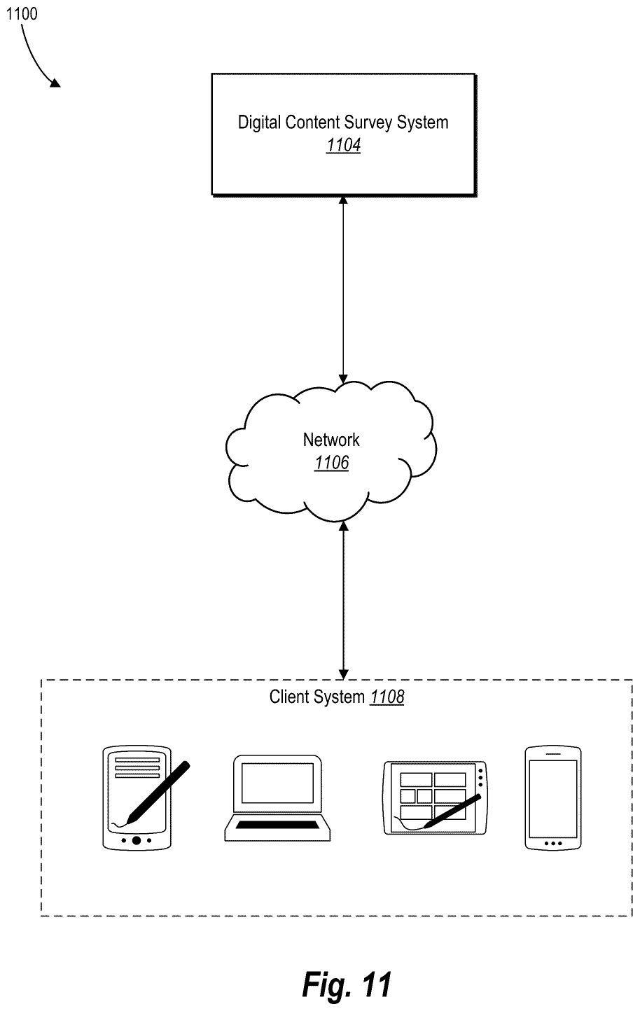

Additionally, the server device(s) 108 can include one or more computing devices including those explained below with reference to FIG. 10. The client device 102, server device(s) 108, and network 114 may communicate using any communication platforms and technologies suitable for transporting data and/or communication signals, including any known communication technologies, devices, media, and protocols supportive of data communications, examples of which are described with reference to FIG. 11.

Although not a requirement, in one embodiment the account prioritization system 106 can be part of the electronic survey system 110. Accordingly, as shown in FIG. 1, the server device(s) 108 hosts an electronic survey system 110, which includes the account prioritization system 106. In one or more embodiments, the electronic survey system 110 collects survey responses to generate datasets (e.g., including experience data and/or organization data) and the account prioritization system 106 receives and utilizes this survey data to determine various metrics and scores. In other embodiments, the server device(s) 108 can include a system other than electronic survey system 110 for collecting, generating, accessing, or otherwise managing data. Additionally, the server device(s) 108 can receive datasets via the network 114 from the client device 102, the third-party server(s) 112 or from another source.

The third-party server(s) 112 can correspond to a variety of systems that track a variety of data for accounts corresponding to the account prioritization system 106. To illustrate, the third-party server(s) 112 can include servers for systems that track or manage sales data, calendar data, user or customer data, financial data, location data, and a variety of other system types. In one or more embodiments, the third-party server(s) provide data to the server device(s) 108 and the account prioritization system 106 via the network 114.

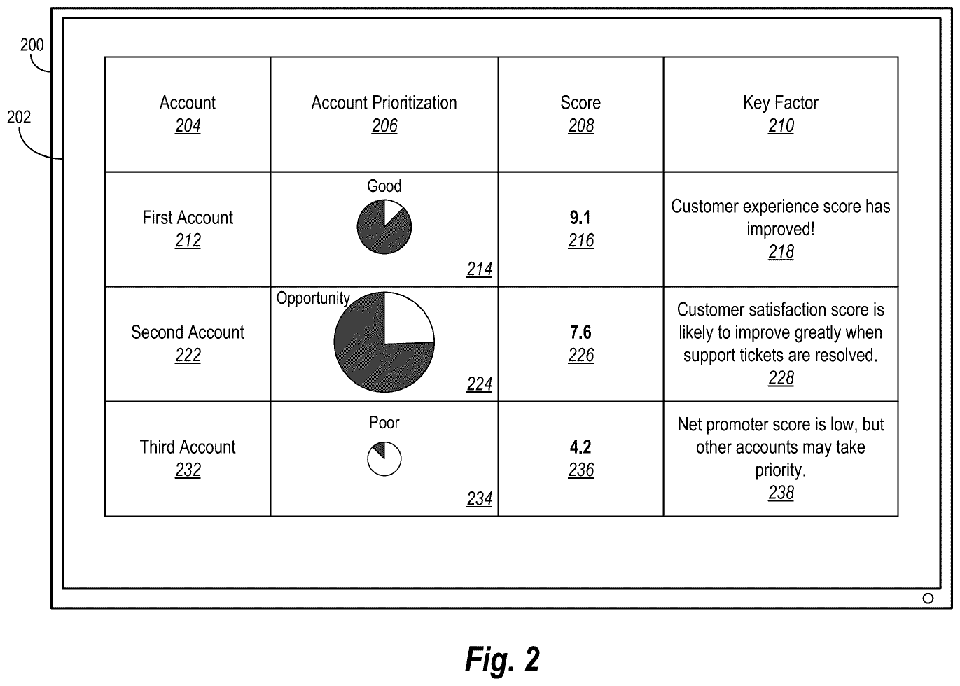

FIG. 2 illustrates an example graphical user interface for providing an account prioritization score, key factor, and other visualizations. More specifically, FIG. 2 illustrates a computing device 200 presenting a graphical user interface 202. The graphical user interface 202 includes a chart with an account column 204, an account prioritization visualization column 206, an account prioritization score column 208, and a key factor column 210. Additionally, the graphical user interface 202 includes information corresponding to a first account 212, a second account 222, and a third account 232.

As shown in FIG. 2, the account column 204 includes a listing of accounts. More specifically, the account column 204 includes listings for the first account 212, the second account 222, and the third account 232. In one or more embodiments, the account prioritization system 106 generates the graphical user interface to include a variety of accounts in the account column 204. For example, based on receiving an indication of a user scroll via the computing device 200, the account prioritization system 106 can provide additional user account rows via the graphical user interface 202.

The graphical user interface 202 includes various information corresponding to the first account 212, the second account 222, and the third account 232. To illustrate, as also shown in FIG. 2, the account prioritization visualization column 206 includes pie charts of varying sizes and a corresponding label. More specifically, the account prioritization visualization column 206 includes the account prioritization visualizations 214, 224, 234. As shown in FIG. 2, the account prioritization visualization 214 includes a pie chart with a large majority of the pie chart shaded and the label “Good.” The account prioritization visualization 224 includes a pie chart with approximately three quarters of the pie chart shaded and the label “Opportunity.” Additionally, the account priority visualization 234 includes a pie chart with very little of the pie chart shaded and the label “Poor.”

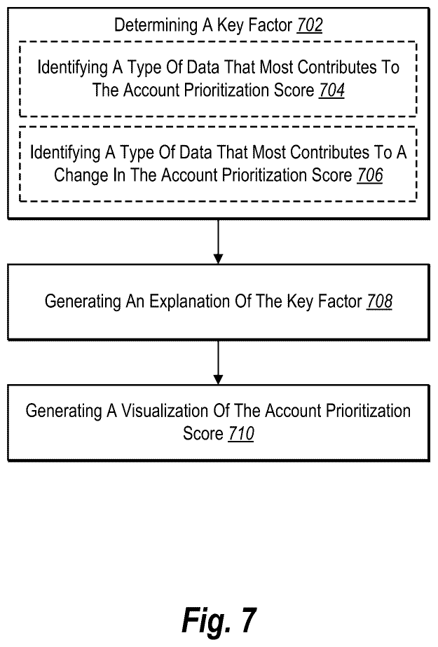

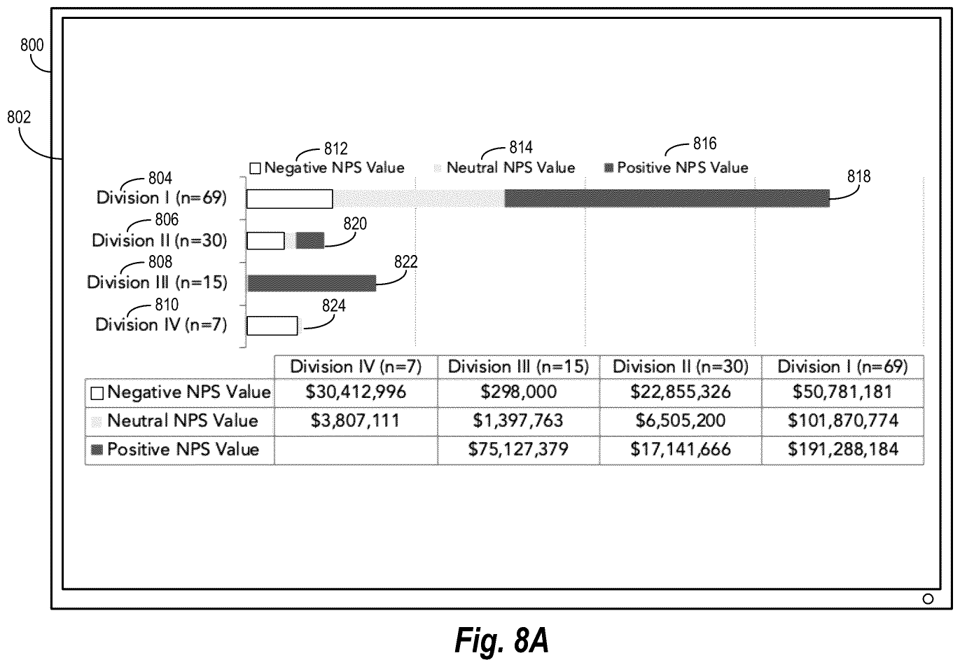

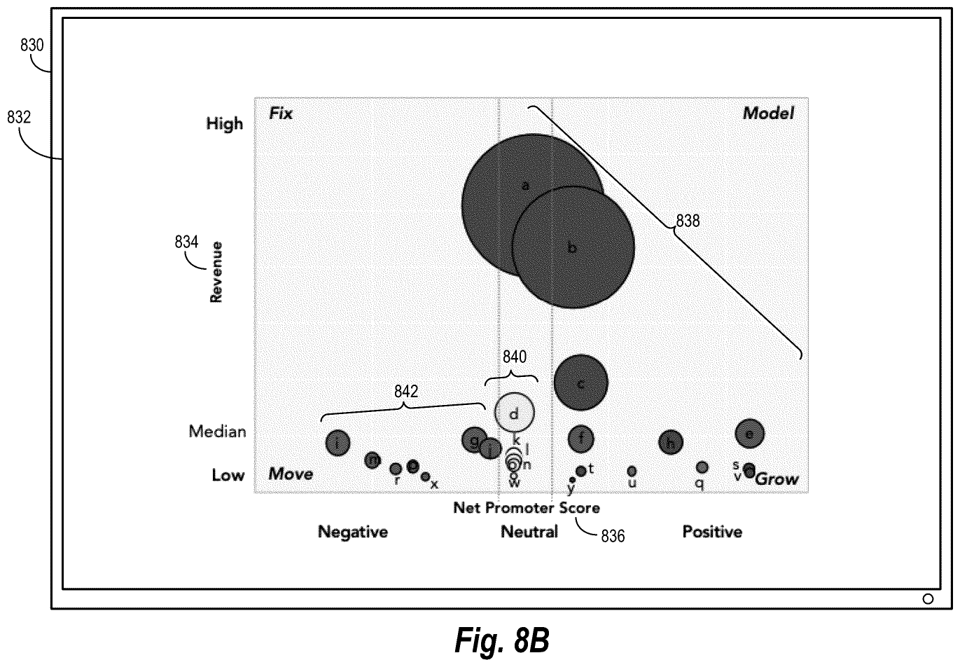

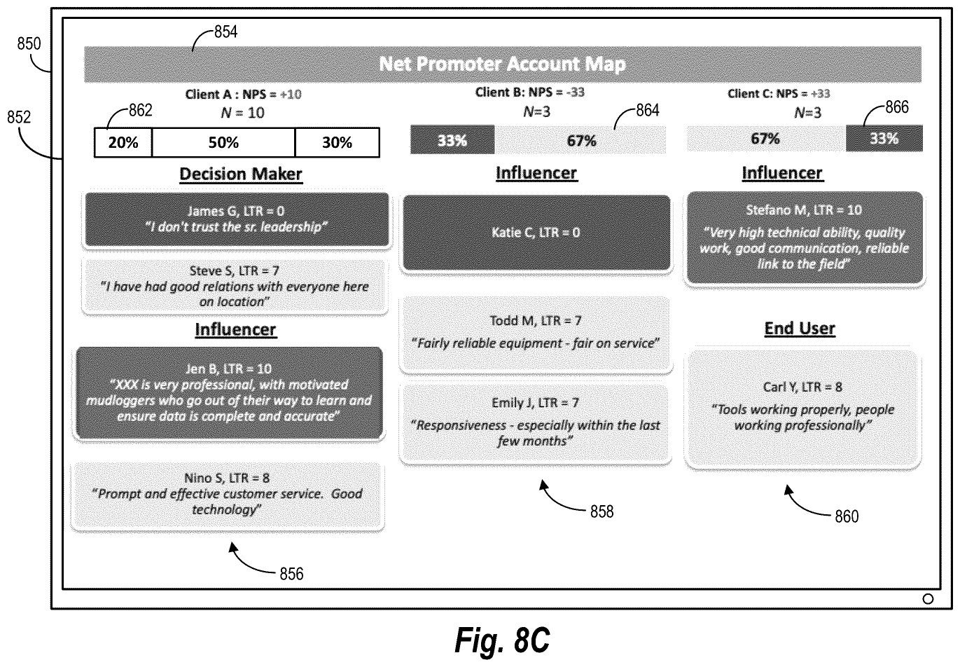

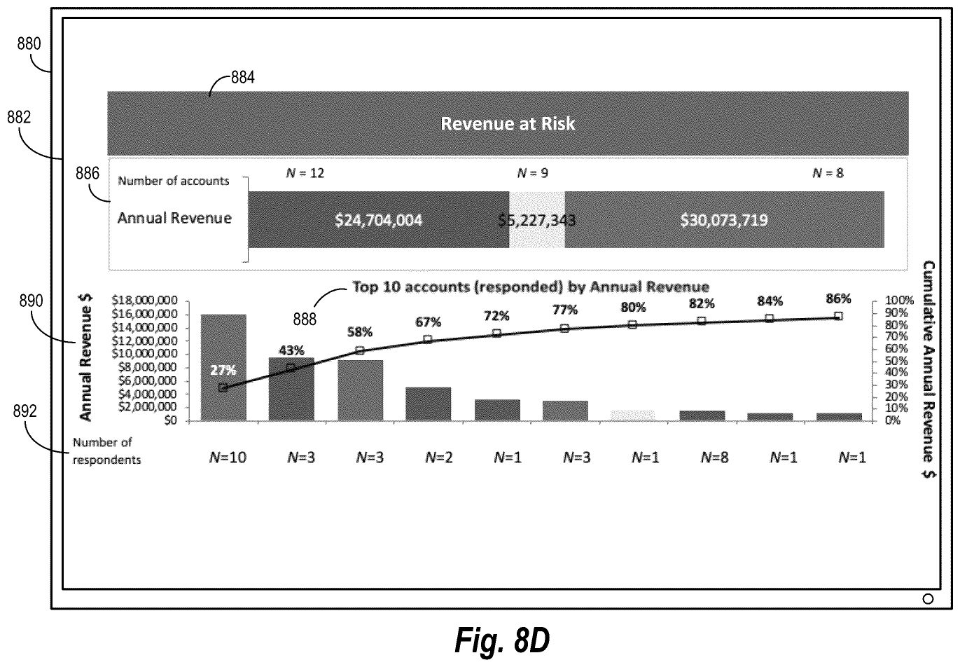

The account prioritization visualizations 214, 224, 234 include pie charts of various sizes. The account prioritization system 106 generates the account prioritization visualizations 214, 224, 234 to reflect both the score of an account prioritization system 106 and a scale corresponding to the account prioritization score. To illustrate, the size of the pie charts can reflect an urgency and/or size corresponding to the account. Additionally, the account prioritization visualizations 214, 224, 234 include text corresponding to a priority category. Thus, the account prioritization visualizations 214, 224, 234 include a variety of information that is easily recognizable at a glance as to the prioritization of various accounts. As will be discussed in greater detail below with regard to FIG. 7 and FIGS. 8A-8D, the account prioritization system 106 can generate account priority visualizations with a variety of chart types, graph types, labels, shades, colors, etc. For example, in one or more embodiments, the account prioritization system 106 can utilize red in visualizations corresponding to a negative priority category, green in visualizations corresponding to a positive priority category, and yellow in visualizations corresponding to neutral or moderate priority categories.

Additionally, the account prioritization score column 208 includes account prioritization scores 216, 226, 236. To illustrate, the account prioritization score 216 is 9.1, the account prioritization score 226 is 7.6, and the account prioritization score 236 is 4.2. As shown in FIG. 2, the account prioritization scores 216, 226, 236 are scores out of ten. However, as will be discussed in greater detail below, in one or more embodiments, the account prioritization system 106 can generate account prioritization scores on a variety of scales and based on a variety of criteria.

Further, the key factor column 210 includes the key factor explanations 218, 228, 238. More specifically, the key factor explanation 218 includes the text, “Customer experience score has improved!” Additionally, the key factor explanation 228 includes the text, “Customer satisfaction score is likely to improve greatly when support tickets are resolved.” Further, the key factor explanation 238 includes the text “Net promoter score is low, but other accounts may take priority.” Each of the key factor explanations 218, 228, 238 highlight an important metric or other criteria and explain how that metric is contributing to the overall account prioritization score.

In one or more embodiments, the account prioritization system 106 generates key factor explanations by identifying a key factor that significantly contributes to the account prioritization score and generating text to explain how the key factor is contributing to the overall account prioritization score. Accordingly, the account prioritization score can generate key factor explanations for a variety of account prioritization score formula types based on a variety of criteria. Additionally, in one or more embodiments, the account prioritization system 106 generates the key factor explanations for a variety of contribution types, including for key factors that most contribute to an account prioritization score, key factors that most contribute to a recent change in the account prioritization score, and/or key factors that could most contribute to a future change in the account prioritization score.

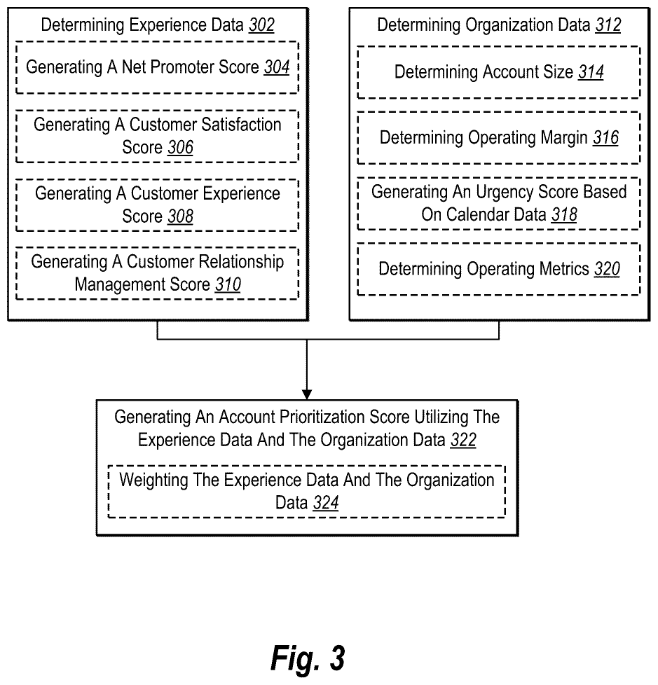

Accordingly, the account prioritization system 106 generates a graphical user interface to provide account prioritization scores and additional information corresponding to the account prioritization score. As mentioned above, the account prioritization system 106 generates the account prioritization score based on experience data and organization data. FIG. 3 provides additional detail for the process of generating the account prioritization score.

As shown in FIG. 3, the account prioritization system 106 can perform an act 302 of determining experience data. Experience data includes a variety of metrics, scores, and criteria related to user and/or customer experience with an entity. As mentioned above with regard to FIG. 1, in one or more embodiments, the account prioritization system 106 receives one or more experience data metrics from an electronic survey system. Additionally, or in the alternative, the account prioritization system 106 receives experience data from one or more third-party systems or determines the experience data at the account prioritization system 106.

In one or more embodiments, the account prioritization system 106 can utilize one or more experience data metrics to determine an account health score. Further, the account prioritization system 106 can utilize one or more subjective assessments to generate an account health score. In some embodiments, the account prioritization system 106 can utilize this account health score to determine the account prioritization score. Additionally, in some embodiments, the account prioritization system 106 can utilize the account health score to generate a visualization for the account prioritization score. To illustrate, the account prioritization system 106 can utilize the account health score to show the overall health of an account and organization data to show relative urgency or importance. To illustrate, the account prioritization system 106 can utilize an account health score to generate a pie chart with a degree of shading, and can utilize organization data to determine the size of that pie chart within a graphical user interface.

As shown in FIG. 3, the act 302 includes an optional act 304 of generating a net promoter score. In one or more embodiments, a net promoter score reflects the loyalty of customers or users for an account. For example, in one or more embodiments, the account prioritization system 106 generates or utilizes a net promoter score that reflects a proportion of users in different loyalty categories. To illustrate, the account prioritization system 106 can generate a net promoter score by determining a proportion of users in a promoter category for users that are loyal and enthusiastic, a passive category for users that are generally satisfied, and a detractor category for users that are unhappy or unsatisfied. More specifically, the account prioritization system 106 can determine a net promoter score by subtracting a percentage of detractors from a percentage of promoters.

Additionally, in one or more embodiments, as shown FIG. 3, the act 302 includes an optional act 306 of generating a customer satisfaction score. In one or more embodiments, the account prioritization system 106 generates a customer satisfaction score that reflects overall customer satisfaction corresponding to an account. To illustrate, the account prioritization system 106 can generate a customer satisfaction score based on survey data indicating numerical scores reported from users for overall satisfaction. In one or more embodiments, the account prioritization system 106 generates the customer satisfaction score by categorizing scores as satisfied or not satisfied and calculating a percentage of satisfied users. For example, for a scale of scores from 1-5, the account prioritization system 106 can classify a score of 4 or 5 as satisfied and 1-3 as not satisfied. Then, the account prioritization system 106 can divide the number of satisfied scores by the number of total survey responses to determine the customer satisfaction score.

In one or more embodiments, the act 302 includes an optional act 308 of generating a customer experience score. In one or more embodiments, a customer experience score reflects the success of a goal to consistently deliver positive experiences to users. For example, the account prioritization system 106 can determine a customer experience score by determining a percentage of users that have a set number of positive interactions over a set time period and/or in a row. To illustrate, given a goal of 5 positive experiences in a row, the account prioritization system 106 can determine the number of users reporting satisfaction in all five most recent survey responses and divide by the total number of users having at least five survey responses.

Additionally, in some embodiments, the act 302 includes an optional act 310 of generating a customer relationship management score. In one or more embodiments, the customer relationship management score reflects a broad variety of data reflecting every experience that customers or users have with an account. In one or more embodiments, the account prioritization system 106 determines a variety of customer relationship management scores reflecting satisfaction at different points in a customer journey. Additionally, the account prioritization system 106 can determine a customer relationship management score reflecting overall sentiment across all interactions with an account. For example, the account prioritization system 106 can determine a total number of positive survey responses and divide it by the total number of survey responses to determine a customer relationship management score for an account.

As also shown in FIG. 3, the account prioritization system 106 can perform an act 312 of determining organization data. In one or more embodiments, the account prioritization system 106 receives organization data from various third-party systems corresponding to accounts. For example, the account prioritization system 106 can receive organization data from sales systems, scheduling systems, accounting or billing systems, customer service systems, etc. The account prioritization system 106 can receive scores, margins, metrics, and criteria from these third-party systems. In addition, or in the alternative, the account prioritization system 106 can utilize raw data from third-party systems to determine various scores, metrics, or other criteria for organization data.

For example, as shown in FIG. 3, the act 312 can include an optional act 314 of determining account size. To illustrate, in one or more embodiments, the account prioritization system 106 can generate an account size by determining a number of customers or users corresponding to an account. Additionally, or in the alternative, the account prioritization system 106 can determine a portfolio size, including based on a number of available products, total revenue, or other size metrics.

As also shown in FIG. 3, the act 312 can include an optional act 316 of determining an operating margin. To illustrate, in one or more embodiments, the account prioritization system 106 can determine a performance ratio reflecting the percentage of return received during operation. In one or more embodiments, the account prioritization system 106 determines an operating margin as a percentage.

Further, the act 312 can include an optional act 318 of generating an urgency score based on calendar data. To illustrate, in one or more embodiments, the account prioritization system 106 can receive calendar data from a third-party system including event data, deadline data, etc. Accordingly, in one or more embodiments, the account prioritization system 106 can generate a score reflecting upcoming events and deadlines. For example, the account prioritization system 106 can determine the urgency score as a number of events within a month from the present date. In addition, or in the alternative, the account prioritization system 106 can determine weights for the calendar events or deadlines based on attendance size, number of documents due, etc. Thus, the account prioritization system 106 can determine an urgency score based both on a number of events within a given time period and the weight of those events.

As also shown in FIG. 3, the act 312 can include an optional act 320 of determining operating metrics. More specifically, the account prioritization system 106 can determine additional operating metrics such as support volume, product usage, performance compared to targets or forecasts, projected repair time, usage data, total revenue, operating margin, and/or service quality metrics. Additionally, the account prioritization system 106 can utilize a number of overdue invoices, billing history, tenure data, number of renewals, percent change in subscriptions or licenses, portfolio size, login data, feature usage data, referral data, etc.

Additionally, in one or more embodiments, the account prioritization system 106 can utilize subjective assessment data, such as user status data, attrition data, industry or company disruption, etc. The account prioritization system 106 can also utilize service or support data including sentiment data in support interactions, service quality metrics, or order returns. The account prioritization system 106 can also utilize outcome data, such as deployment or adoption rates, portfolio composition, feedback or feature requests, perceived return on investment, and/or expansion opportunities. Additionally, the account prioritization system 106 can utilize engagement data, such as an email response rate, sentiment of emails or messages, and/or attendance rates or consumption rates for content corresponding to an account.

For example, the account prioritization system 106 can determine a support volume based on a number of outstanding support tickets, a number of available support personnel, and/or a number of users otherwise waiting for support. In addition, the account prioritization system 106 can determine product usage as a number of times that an account has utilized account prioritization system 106 services within a given time period. Further, the account prioritization system 106 can determine performance based on goals and performance received from third-party systems or from survey data from an electronic survey system. Additionally, in one or more embodiments, the account prioritization system 106 determines a service quality metric based on a star rating, service modifiers, reservation status, employee qualifications, etc.

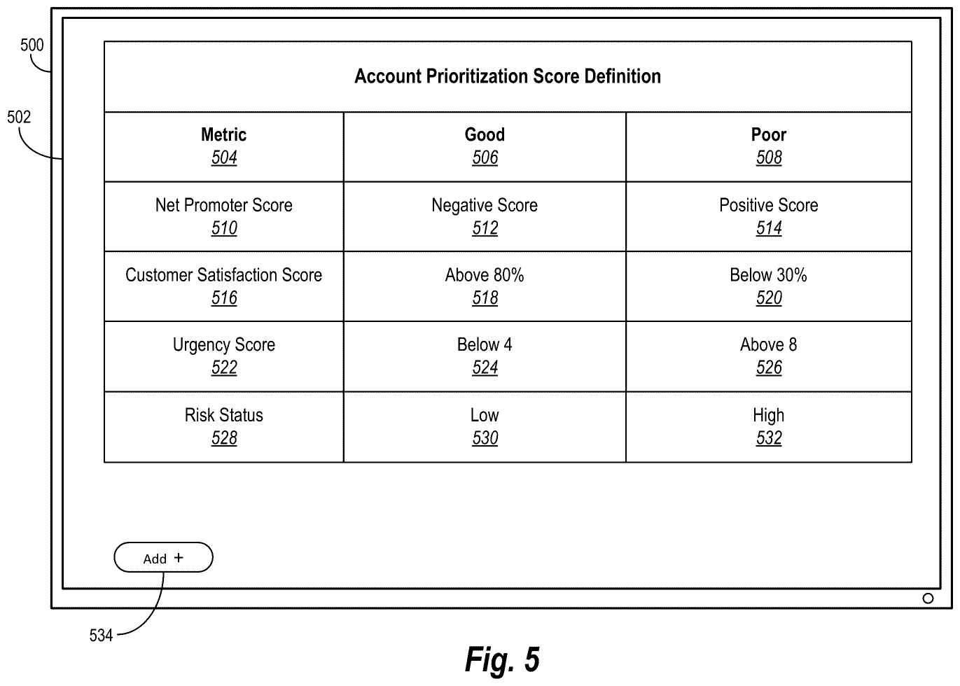

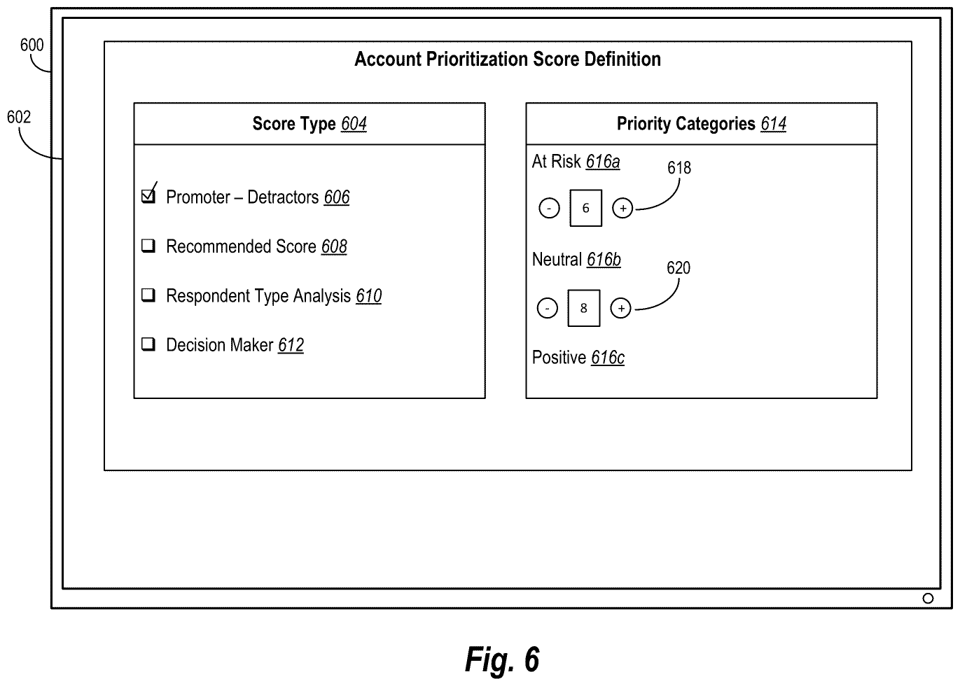

Additionally, as shown in FIG. 3, the account prioritization system 106 performs an act 322 of generating an account prioritization score utilizing the experience data and the organization data. More specifically, the account prioritization system 106 can utilize the experience data determined at the act 302 and the organization data determined at the act 312 to determine an account prioritization system 106. As will be discussed in greater detail below with regard to FIGS. 5-6, the account prioritization system 106 can determine which metrics and criteria to utilize in determining the account prioritization score based on administrator input. In addition, or in the alternative, the account prioritization system 106 can determine the account prioritization score based on a default formula utilizing particular metrics and scores.

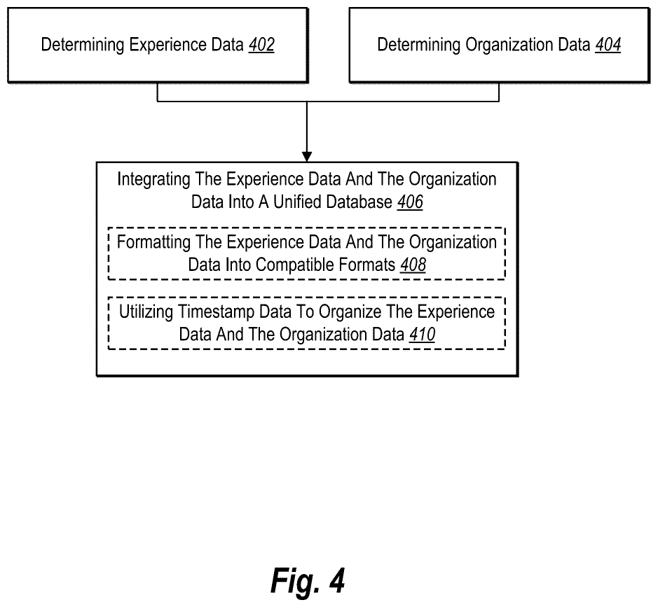

Further, as will be discussed in greater detail below with regard to FIG. 4, the account prioritization system 106 can utilize experience data and organization data from various systems by re-formatting the data and integrating it into a single, unified database. To illustrate, in one or more embodiments, the account prioritization system 106 receives data in various formats, organizations, and types from a variety of third-party systems. In some embodiments, the account prioritization system 106 re-formats the data and organizes the data based on timestamps. Thus, the account prioritization system 106 can efficiently retrieve a variety of metrics, scores, and other data in order to generate account prioritization scores utilizing data from various disparate sources and systems.

As shown in FIG. 3, the act 322 can include an act 324 of weighting the experience data and the organization data. In one or more embodiments, the account prioritization system 106 weights specific metrics and scores in order to determine the account prioritization score for an account. In some embodiments, the account prioritization system 106 weights the experience data and the organization data, including various specific metrics, based on administrator input or selection. In addition, or in the alternative, in one or more embodiments, the account prioritization system 106 determines weights for the experience data and the organization data, including the various specific metrics based on a pre-determined formula and/or user selection among pre-determined formulae.

As mentioned above, in one or more embodiments, the account prioritization system 106 receives experience data and organization data from various third-party systems. FIG. 4 illustrates a process for integrating experience data and organization data from different, disparate third-party systems. Thus, the account prioritization system 106 can utilize this data from various systems to determine a unified account prioritization score.

As shown in FIG. 4, the account prioritization system 106 can perform an act of determining experience data 402. In some embodiments, the account prioritization system 106 receives the experience data from an electronic survey system. In addition, or in the alternative, in one or more embodiments, the account prioritization system 106 receives experience data from a third-party system, such as a social media system, an error reporting system, a customer support system, or another system with data corresponding to user or customer experience. The account prioritization system 106 can receive experience data in a variety of formats including as raw data or as determined metrics.

Additionally, the account prioritization system 106 can perform an act 404 of determining organization data. In one or more embodiments, the account prioritization system 106 receives the organization data from a third-party system, such as a sales system, a scheduling system, an accounting or billing system, and/or a customer service system. Further, in one or more embodiments, the account prioritization system 106 receives organization data from another system that utilizes and/or stores data related to an organization's activities.

As also shown in FIG. 4, in one or more embodiments, the account prioritization system 106 performs an act 406 of integrating the experience data and the organization data into a unified database. More specifically, in one or more embodiments, the account prioritization system 106 receives the experience data and/or the organization data in a variety of formats from various third-party systems. Accordingly, in some embodiments, the account prioritization system 106 receives data that is not compatible with other received data. Thus, in order to utilize the data from the different systems to generate an account prioritization score, the account prioritization system 106 integrates various experience data and organization data into a unified database.

To illustrate, the act 406 can include an optional act 408 of formatting the experience data and the organization data into compatible formats. More specifically, in one or more embodiments, the account prioritization system 106 identifies data that will be utilized to generate an account prioritization score. Then, the account prioritization system 106 can re-format any incompatible data into a format that can be stored in the database.

Accordingly, the account prioritization system 106 can generate an account prioritization score utilizing each piece of data indicated by the utilized account prioritization score formula. Further, the act 406 can include an optional act 410 of utilizing timestamp data to organize the experience data and the organization data. More specifically, in one or more embodiments, the account prioritization system 106 organizes the experience data and the organization data based on which account prioritization score it was utilized to determine. In one or more embodiments, the account prioritization system 106 organizes its database so that each account prioritization score is stored with its associated component data.

Further, the account prioritization system 106 can organize experience data and organization data by labelling each data point with a unique identifier. In some embodiments, the account prioritization system 106 generates unique identifiers based on the associated account, the third-party system where the data originated, and a timestamp associated with the data. Further, the account prioritization system 106 can generate a timestamp for each account prioritization score based on when the account prioritization score was generated. Additionally, the account prioritization system 106 can store each account prioritization score with its component data.

As mentioned above with regard to FIG. 3, in some embodiments, the account prioritization system 106 also generates account health scores that integrate the experience data corresponding to an account prioritization score. In some embodiments, the account prioritization system 106 stores account health scores corresponding to each account prioritization score in the same location as the account prioritization score in order to facilitate efficient retrieval. Further, in one or more embodiments, the account prioritization score stores key factors and/or key factor explanations at the same location as the corresponding account prioritization score for efficient retrieval.

In one or more embodiments, the account prioritization system 106 utilizes the database to determine key factors for account prioritization scores. Thus, in some embodiments, the account prioritization system 106 formats the database in an array of criteria as potential key factors. In one or more embodiments, the account prioritization system 106 stores experience data and organization data in an array with corresponding fields indicating types of data, such as a metric, a factor, a value, a period, an enumeration, a number, a string, Boolean data, and/or other data types and tags. In addition, or in the alternative to an array, the account prioritization system 106 can store the experience data, the organization data, and the corresponding tags as a stringified object notation (e.g., a JavaScript Object Notation). As will be discussed in greater detail below with regard to FIG. 7, this organization enables efficient determination of key factors and key factor explanations.

Thus, in one or more embodiments, the account prioritization system 106 generates a unified database with account prioritization scores, account health scores, key factors, and all associated component experience data and organization data. Thus, the account prioritization system 106 can make account prioritization score history data available and searchable to administrator devices corresponding to accounts.

In one or more embodiments, the account prioritization system 106 stores the account prioritization scores and the associated data by running batch jobs at regular intervals. Further, the account prioritization system 106 can make iterative changes to the database without replacing or overwriting past historical data. Thus, the account prioritization system 106 can store priority information over time while allowing changes in the account prioritization score formula or component data. Accordingly, the account prioritization system 106 can produce priority history reports for various periods of time (e.g., last two years, last 14 days, etc.).

In addition, or in the alternative, the account prioritization system 106 can organize the data by tagging metrics, scores, or other data with partition keys and/or sort keys. More specifically, the account prioritization system 106 can generate a tag based on partitioning or sorting criteria, including based on priority categories, time, or associated account. Thus, the account prioritization score can utilize the partition keys and/or sort keys to quickly query, locate, and provide different metrics, scores, and other data.

As mentioned above, in one or more embodiments, the account prioritization system 106 determines a formula for an account prioritization score based on administrator selections. In addition, the account prioritization system 106 can determine priority categories based on administrator selections. FIG. 5 illustrates an example graphical user interface for defining metrics for use in an account prioritization score and corresponding priority categories.

More specifically, FIG. 5 illustrates an administrator device 500 presenting a graphical user interface 502 including a chart with a metric column 504, a good priority category column 506, and a poor priority category column 508. Additionally, the graphical user interface 502 includes user input fields 510-532 in the account prioritization score definition chart.

In one or more embodiments, the administrator device 500 can detect administrator interaction with the user input fields 510-532. In one or more embodiments, the account prioritization system 106 provides the user input fields 510-532 to receive text input, as drop-down menus, to receive queries for existing potential field entries, etc. In some embodiments, the account prioritization system 106 receives user interaction selecting metrics, scores, rules, and/or other criteria via the user input fields 510-532.

To illustrate, the metric column 504 includes the user input fields 510, 516, 522, 528. More specifically, the user input field 510 includes a net promoter score, the user input field 516 includes a customer satisfaction score, the user input field 522 includes an urgency score, and the user input field 528 includes a risk status. In one or more embodiments, the account prioritization system 106 provides the user input fields 510, 516, 522, 528 as shown in FIG. 5 in response to receiving administrator input selecting each of the metrics in the user input fields 510, 516, 522, 528. Additionally, in some embodiments, the account prioritization system 106 generates an account prioritization score formula based on the user selection of the metrics via the user input fields 510, 516, 522, 528. To illustrate, based on receiving user input selecting a net promoter score, a customer satisfaction score, an urgency score, and a risk status score, the account prioritization system 106 generates a formula for an account prioritization score that includes each of these metrics.

Though FIG. 5 illustrates one possible combination of metrics in the metric column 504, it will be appreciated that the account prioritization system 106 can receive user input corresponding to a variety of metrics and criteria. Thus, the account prioritization system 106 can generate account prioritization scores based on a variety of user input selecting a variety of metrics. To illustrate, the account prioritization system 106 can generate an account prioritization score formula based on receiving user selection of any of a variety of scores or metrics via the user input fields 510, 516, 522, 528. Accordingly, the account prioritization system 106 generates an account prioritization score formula that includes each score or metric in the metric column 504.

In one or more embodiments, the account prioritization system 106 further provides an additional option for selecting a weight corresponding to the selected metric or score in response to receiving user selection of the metric or score via the graphical user interface. The account prioritization system 106 can generate the account prioritization score formula based on user selection of a weighting factor. In addition, or in the alternative, the account prioritization system 106 can determine a weight based on more qualitative selections, such as a high, medium, and low weight for a particular metric or score.

As shown in FIG. 5, the account prioritization system 106 can also receive administrator input defining priority categories. More specifically, the account prioritization system 106 can receive user input selecting criteria corresponding to priority categories in the good priority category column 506 and the poor priority category column 508. Further, the account prioritization system 106 can determine that the user input corresponding to the good priority category column 506 and the poor priority category column 508 also corresponds to the metric from the metric column 504 listed in the same row as the user input.

In one or more embodiments, the account prioritization system 106 utilizes the criteria listed in the user input fields 510-532 to categorize account prioritization scores into priority categories. In some embodiments, the account prioritization system 106 categorizes an account prioritization score into a priority category if it meets each of the criteria in the corresponding priority category column. In addition, or in the alternative, the account prioritization system 106 categorizes an account prioritization score into the priority category that it meets the most criteria of. In some embodiments, the account prioritization system 106 can categorize an account prioritization score into a category based on highly weighted metrics in the account prioritization score formula. To illustrate, in one or more embodiments, the account prioritization system 106 categorizes an account prioritization score utilizing component metrics that meet a weighting threshold.

Further, in one or more embodiments, the account prioritization system 106 categorizes an account prioritization score into a priority category if it meets any of the criteria included in the corresponding priority category column. Additionally, in some embodiments, the account prioritization system 106 categorizes an account prioritization score that does not fulfil the criteria of any priority column into a neutral priority category. Further, in one or more embodiments, the account prioritization system 106 categorizes an account prioritization score that fulfils the criteria for multiple priority columns into a neutral priority category.

For example, as shown in FIG. 5, the user input field 510 includes the text net promoter score, the user input field 512 includes the text “negative score,” and the user input field 514 includes the text “positive score.” In one or more embodiments, based on receiving the user input at the user input fields 510, 512, 514, the account prioritization system 106 determines that an account prioritization score including a negative net promoter score corresponds to a good priority category. Additionally, the account prioritization system 106 determines that an account prioritization score including a positive net promoter score corresponds to a poor priority category.

Additionally, as shown in FIG. 5, the user input field 516 includes the text customer satisfaction score, the user input field 518 includes the text “above 80%,” and the user input field 520 includes the text “below 30%.” In one or more embodiments, based on receiving the user input at the user input fields 516, 518, 520, the account prioritization system 106 determines that an account prioritization score including a customer satisfaction score above 80% corresponds to a good priority category. Additionally, the account prioritization system 106 determines that an account prioritization score including a customer satisfaction score under 30% corresponds to a poor priority category.

Further, as shown in FIG. 5, the user input field 522 includes the text urgency score, the user input field 524 includes the text “Below 4,” and the user input field 526 includes the text “Above 8.” In one or more embodiments, based on receiving the user input via the user input fields 522, 524, 526, the account prioritization system 106 determines that an account prioritization system 106 including an urgency score below 4 corresponds to a good priority category. Further, the account prioritization system 106 determines that an account prioritization score including an urgency score above 8 corresponds to a poor priority category.

FIG. 5 also shows that the user input field 528 includes the text risk status, the user input field 530 includes the text “Low,” and the user input field includes the text “High.” In one or more embodiments, based on receiving the user input selecting these criteria via the user input fields 528, 530, 532, the account prioritization system 106 determines that an account prioritization score including a risk status in a low category corresponds to a good priority category. Additionally, the account prioritization score determines that an account prioritization score including a risk status in a high category corresponds to a poor priority category.

Additionally, the account prioritization system 106 can modify an account prioritization score formula or priority categories based on receiving modifications via the graphical user interface 502. To illustrate, the account prioritization system 106 can receive user input via the administrator device 500 indicating modifications to the user input fields 510-532. Based on receiving the user input indicating the modifications, the account prioritization system 106 can also modify the account prioritization score and criteria for priority categories corresponding to the affected user input fields.

Further, as shown in FIG. 5, the graphical user interface 502 includes an add button 534. In response to receiving an indication of user selection of the add button 534, the account prioritization system 106 can add a row to the graphical user interface 502 including user input fields for each of the metric column 504, the good priority category column 506, and the poor priority category column 508. Upon receiving user interactions with the new row, the account prioritization system 106 can also update the account prioritization score and criteria for priority categories corresponding to the affected user input fields.

Turning to FIG. 6, the account prioritization system 106 can also provide one or more pre-determined formulae for account prioritization scores. FIG. 6 illustrates an example graphical user interface for selection of account prioritization score formulae and customization of corresponding priority categories. More specifically, FIG. 6 illustrates an administrator device 600 presenting a graphical user interface 602.

As shown in FIG. 6, the administrator device 600 presents a score type box 604. The score type box 604 includes four options for account prioritization scores: a promoter-detractor option 606, a recommend score option 608, a respondent type analysis 610, and a decision maker 612. FIG. 6 illustrates the score type box 604 including four options, but the account prioritization system 106 can generate and provide a variety of formula options for account prioritization scores via the administrator device 600. In some embodiments, in response to receiving an indication of user interaction with the score type box 604 via the administrator device 600, the account prioritization system 106 indicates a selected option via the administrator device 600. Further, the account prioritization system 106 generates an account prioritization score based on the user selection at the score type box 604.

The account prioritization system 106 can also utilize a variety of account prioritization score formulas not shown in FIG. 6. For example, the account prioritization system 106 can determine an account prioritization score based on a net promoter score over a pre-determined time period and/or a net promoter score trend or change over a pre-determined time period. Further, the account prioritization system 106 can determine an account prioritization score as a combination of the net promoter score and the trend. More specifically, in one or more embodiments, the account prioritization system 106 determines the account prioritization score as the net promoter score over the predetermined time period plus 25% of the trend or change over the pre-determined time period.

In addition, or in the alternative, the account prioritization system 106 can determine an account prioritization score as double a customer satisfaction score over a pre-determined time and/or double a trend or change over a pre-determined time period. Further, in one or more embodiments, the account prioritization system 106 determines the account prioritization score as a combination of the customer satisfaction score and the trend. To illustrate, in one or more embodiments, the account prioritization system 106 determines the account prioritization score as the customer satisfaction score over the predetermined time period plus 25% of the trend or change over the pre-determined time period.

The account prioritization system 106 can also determine account prioritization score formulae utilizing a number of “open cases,” such as support tickets, unresolved issues, etc. More specifically, in one or more embodiments, the account prioritization system 106 determines an account prioritization system 106 based on an experience metric plus a trend and minus a number of cases. In addition, or in the alternative, the account prioritization system 106 can utilize a portion or percentage of a trend to determine the account prioritization score.

In addition to providing pre-defined account prioritization score formulae for utilization, the account prioritization system 106 can utilize predictive modelling to generate and modify account prioritization score formulae. To illustrate, in one or more embodiments, the account prioritization system 106 can generate an account prioritization score model based on historical data corresponding to an attrition rate of users from various accounts. In addition, or in the alternative, the account prioritization system 106 can generate weighting for particular accounts by identifying metrics that correspond to users leaving an account.

For example, the account prioritization system 106 can determine that a low score for a particular metric meets a threshold association with a user leaving the account. Based on this determination, in one or more embodiments, the account prioritization system 106 can increase the weight of the metric in the account prioritization score. Accordingly, the account prioritization system 106 can automatically customize account prioritization score formulae for the needs of specific accounts. Thus, the account prioritization system 106 can respond to account-specific factors in generation of account prioritization scores.

In one or more embodiments, the promoter-detractor option 606 corresponds to an account prioritization score including a net promoter score. More specifically, the promoter-detractor option 606 includes a metric that the account prioritization system 106 determines by subtracting a proportion of detractors from a proportion of promotors based on received sentiment data from users or customers. In some embodiments, the promoter-detractor option 606 includes additional metrics and criteria, including metrics or scores as discussed above. In one or more embodiments, the account prioritization system 106 also associates priority categories with the account prioritization score where a positive net promoter score is associated with a positive priority category, a net promoter score of zero is associated with a neutral priority category, and a negative net promoter score is associated with a negative priority category.

Additionally, in one or more embodiments, the recommend score option 608 corresponds to an account prioritization score including an average recommendation score. To illustrate, in some embodiments, the recommend score option 608 corresponds to an account prioritization score that includes an average of responses to a recommendation survey question out of ten. In one or more embodiments, the account prioritization system 106 also associates priority categories with the account prioritization system 106 where an average at or above 8.45 is associated with a positive priority category, an average between 5.45 and 8.45 is associated with a neutral priority category, and an average at or below 5.45 is associated with a negative priority category.

Also, in some embodiments, the respondent type analysis 610 corresponds to an account prioritization score including a comparison of users that the account prioritization system 106 categorizes as promoters, detractors, and passives. As mentioned above, the account prioritization system 106 can proportion users in a promoter category for users that are loyal and enthusiastic, a passive category for users that are generally satisfied, and a detractor category for users that are unhappy or unsatisfied. In one or more embodiments, the account prioritization system 106 determines an account prioritization score associated with the respondent type analysis 610 by determining whether the account falls into a positive priority category because the number of promoters is larger than the total number of detractors and passives. Additionally, the account prioritization system 106 can determine whether the account falls into a negative priority category because the number of detractors is larger than the total number of promoters and passives. Further, in one or more embodiments, the account prioritization system 106 determines whether the account falls into a neutral priority category because the number of passives is larger than the total number of promoters and detractors or whether the number of promoters equals the number of detractors.

In one or more embodiments, the decision maker option 612 corresponds to an account prioritization score formula including a determination of influential users or respondents. More specifically, the account prioritization system 106 can utilize a formula for the decision maker option 612 that only considers users or respondents categorized as important. In one or more embodiments, this categorization is received from a third-party system. In addition, or in the alternative, the account prioritization system 106 determines important respondents based on survey data or role data corresponding to respondents. The account prioritization system 106 can utilize a formula for the decision maker option 612 similar to any of the promoter-detractor option 606, the recommend score option 608, or the respondent type analysis 610 but utilizing only data corresponding to important respondents.

In some embodiments, the account prioritization system 106 can receive user selection of both the decision maker option 612 and an additional option in order to generate the account prioritization score formula. For example, if the account prioritization system 106 received, via the administrator device 600, an indication of user inputs selecting each of the decision maker option 612 and the recommend score option 608, the account prioritization system 106 generates an account prioritization score formula that determines a recommendation score based on an average of responses from important users or respondents. Further, the account prioritization system 106 can utilize priority categories determined based only on data corresponding to users or respondents categorized as important.

As mentioned, the account prioritization system 106 can determine priority scores based on particular metrics or criteria determined as part of an account prioritization score. In addition, or in the alternative, the account prioritization system 106 can determine and utilize priority categories based on the total account prioritization score. FIG. 6 illustrates the administrator device 600 presenting a priority categories box 614 that includes options for setting score ranges for such priority categories.

To illustrate, as shown in FIG. 6, the priority categories box 614 includes priority categories 616a-616c. More specifically, the priority categories box 614 includes the at risk priority category 616a, the neutral priority category 616b, and the positive priority category 616c. The priority categories box 614 also includes the score selectors 618-620. In one or more embodiments, the account prioritization system 106 sets account prioritization score ranges for priority categories based on received user interactions at the score selectors 618.

In some embodiments, the account prioritization system 106 sets the lower limit for the neutral priority category 616b based on the number selected at the score selector 618 and the upper limit for the neutral priority category 616b based on the number selected at the score selector 620. Further, in one or more embodiments, the account prioritization system 106 determines the score range for the at risk priority category 616a as any score lower than the number selected at the score selector 618. Additionally, in some embodiments, the account prioritization system 106 determines the score range for the positive priority category 616c as any score higher than the number selected at the score selector 620.

As mentioned above, in one or more embodiments, the account prioritization system 106 determines key factors for account prioritization scores. Further, the account prioritization system 106 generates explanations of the key factors for presentation in a graphical user interface. FIG. 7 illustrates a process for determining these key factors, and generating corresponding explanations and visualizations.

As shown in FIG. 7, the account prioritization system 106 performs an act 702 of determining a key factor. More specifically, in one or more embodiments, the act 702 includes an optional act 704 of identifying a type of data that most contributes to the account prioritization score. For example, if a priority score corresponds to the highest or best priority category, the account prioritization system 106 can identify the score or metric contributing the most to the account prioritization score based on weight.

In one example, an account prioritization score formula weights a customer satisfaction score of 90% at 60%, a customer relationship management score of 92/100 at 20%, and an urgency score of 8/10 at 20%. For this example, the account prioritization system 106 determines the account prioritization score as (0.9)(0.6)+(0.92)(0.2)+(0.8)(0.2)=0.884. Then, the account prioritization system 106 determines that the component parts of the score are the account prioritization score is 0.54 for the customer satisfaction score, 0.184 for the customer relationship management score, and 0.16 for the urgency score. Accordingly, the account prioritization system 106 can determine that the key factor in this example is the account customer satisfaction score.

In another example, the account prioritization system 106 can determine a key factor for an account prioritization score in a low category as the component metric with the largest difference between the maximum potential contribution to the score and the actual contribution to the score. To illustrate, if a score is weighted at 60%, its maximum potential contribution is 0.6. Additionally, a score weighted at 0.6 with a 5/10 would have an actual contribution of (0.6)(0.5)=0.3, and accordingly the difference between the maximum potential contribution and the actual contribution is 0.6−0.3=0.3. Thus, by determining the difference between the maximum potential contribution and the actual contribution, the account prioritization system 106 can determine the key factor as the metric with the most potential to improve the total account prioritization score if it is improved.

As also shown in FIG. 7, the act 702 can include an optional act 706 of identifying a type of data that most contributes to a change in the account prioritization score. More specifically, in one or more embodiments, the account prioritization system 106 can identify a metric in the account prioritization score formula that has changed the most over a pre-determined period of time. In addition, or in the alternative, the account prioritization system 106 can identify the key metric as a metric in the account prioritization score formula that has changed the most over a pre-determined period of time while considering the weight of the metrics within the account prioritization score formula.

Further, as shown in FIG. 7, the account prioritization system 106 can perform an act 708 of generating an explanation of the key factor. To illustrate, the account prioritization system 106 can generate an explanation by selecting a phrase with corresponding to how the key factor was selected. Further, the account prioritization system 106 can insert the metric identified as the key factor into the phrase. For example, the account prioritization system 106 can select phrases such as “Your overall score is great because of a high net promoter score,” “Your overall score is low because of a low customer experience score,” “Your net promoter score has dropped, resulting in a decrease in your overall score,” “Your customer satisfaction score has risen, resulting in an increase in your overall score,” “This positive trend is primarily driven by an increase in your customer relationship management score,” etc.

In addition, or in the alternative, the key factor explanation can include specific scores and/or changes in score. To illustrate, the account prioritization system 106 can include the current score for the key factor in the key factor explanation. For example, the account prioritization system 106 can insert the determined metric and its current score into a template phrase, such as “Your overall account prioritization score is high because of a net promoter score of 80%.” In one or more embodiments, the account prioritization system 106 can also utilize prior scores at a predetermined interval. For example, the account prioritization system 106 can generate a key factor explanation including the current score and the score one week ago, such as “Your overall account prioritization score has increased by 12% because your customer satisfaction score increased from 50% to 74%.”

Further, the account prioritization system 106 can utilize a matrix to determine the key factor and/or the explanation of the key factor. More specifically, in one or more embodiments, the account prioritization system 106 can generate a data matrix including the key factor and a reason for the key factor, such as a significant change, the highest contribution, etc. The account prioritization system 106 can also generate the matrix including the value or score for the metric identified as the key factor, a relevant time factor, and a label or template for the key factor explanation that corresponds to the determined metric. Thus, the account prioritization system 106 can efficiently retrieve information corresponding to a key factor explanation. In addition, or in the alternative to the matrix, the account prioritization system 106 can generate a data string organizing the key factor data.

As also shown in FIG. 7, the account prioritization system 106 can perform an act 710 of generating a visualization of the account prioritization score. To illustrate, the account prioritization system 106 can generate a graphic, chart, graph, etc. to show a visual representation of the account prioritization score. More specifically, the account prioritization system 106 can utilize color, size, shape, position, etc. to show various facets an account prioritization score.

Additionally, as mentioned above, the account prioritization system 106 can utilize an account health score based on experience data to generate a visualization for the account prioritization score. To illustrate, the account prioritization system 106 can utilize the account health score to visualize the overall health of an account and organization data to visualize relative urgency or importance. To illustrate, the account prioritization system 106 can utilize an account health score to determine a color or shading for a visualization, and can utilize organization data to determine the size of that visualization within a graphical user interface.

FIGS. 8A-8D illustrate example graphical user interfaces including visualizations of account prioritization scores. FIG. 8A illustrates a computing device 800 including a graphical user interface 802 with a bar graph illustrating account prioritization scores and component metrics within the account prioritization scores. More specifically, the graphical user interface 802 includes data for a division I 804, a division II 806, a division III 808, and a division IV 810. The graphical user interface 802 includes data for an account prioritization score determined based on net promoter score and corresponding size or value associated with that net promoter score. Thus, the account prioritization system 106 generates a graph and chart for the account prioritization score visualizing the scope of the total contributing portions of the net promoter score.

The division I 804 corresponds to a bar 818. The account prioritization system 106 generates the bar 818 to reflect a negative net promoter score value of $50,781,181, a neutral net promoter score value of $101,870,774, and a positive net promoter score value of $191,288,184. Additionally, the division II 806 corresponds to a bar 820. The account prioritization system 106 generates the bar 820 to reflect a negative net promoter score value of $22,855,326, a neutral net promoter score value of $6,505,200, and a positive net promoter score value of $17,141,666. Further, the division III 808 corresponds to a bar 822. The account prioritization system 106 generates the bar 822 to reflect a negative net promoter score value of $298,000, a neutral net promoter score value of $1,397,763, and a positive net promoter score value of $75,127,379. Also, the division IV 810 corresponds to a bar 824. The account prioritization system 106 generates the bar 824 to reflect a negative net promoter score value of $30,412,996, a neutral net promoter score value of $3,807,111, and no positive net promoter score value.

The bar graph in the graphical user interface 802 communicates both scope and sentiment corresponding to each of the division accounts. Thus, the account prioritization system 106 generates an account prioritization score visualization as a bar graph that reflects both sentiment as expressed by a net promoter score and the corresponding scope or value of that sentiment. Accordingly, the account prioritization system 106 generates a visualization that efficiently communicates both scope and sentiment according to a variety of accounts. In addition, as illustrated in FIG. 8A, the graphical user interface 802 can include a legend indicating which portions of the bar graphs represent a negative NPS value 812, a neutral NPS value 814, and a positive NPS value 816 based on shading or color.

Turning to FIG. 8B, the account prioritization system 106 can also generate an account prioritization score visualization as a scatter plot. FIG. 8B illustrates a computing device 830 presenting a graphical user interface 832 that includes a scatter plot. More specifically, the graphical user interface 832 includes a revenue axis 834 that runs from low to high and a net promoter score axis 836 that runs from negative to neutral to positive. The graphical user interface also includes labels for the corners of the axes corresponding to priority categories: fix, move, model, and grow.

The account prioritization system 106 places circles representing account prioritization scores in the graphical user interface 832 along the revenue axis 834 and the net promoter score axis 836. Further, the account prioritization system 106 determines the size of the circle based on the overall revenue associated with the account prioritization score. As also shown in FIG. 8B, the account prioritization system 106 generates a shade for each account prioritization score based on a priority category. To illustrate, an account visualization grouping 838 includes a dark shading corresponding to a positive account prioritization score. Additionally, an account visualization grouping 840 includes a light shading corresponding to a neutral priority category. Further, an account visualization grouping 842 includes a moderate shading corresponding to a negative priority category.

In one or more embodiments, the account prioritization system 106 can generate a scatter plot based on a variety of metrics or criteria utilized in an account prioritization score formula. Additionally, the account prioritization system 106 can show various categorizations of account prioritization scores, including priority categories, based on a variety of visual indicators in addition to shading. For example, the account prioritization system 106 can utilize shape, color, opacity, and other visual cues to show different categorizations for accounts.

FIG. 8C illustrates an account prioritization score visualization including a net promoter account map. More specifically, FIG. 8C illustrates a computing device 850 presenting a graphical user interface 852 including a net promoter account map 854. The net promoter account map 854 includes columns 856, 858, 860. Further, the net promoter account map 854 includes various survey responses shaded according to a corresponding priority category associated with the survey response, with a dark shade corresponding to a positive priority category, a medium shade corresponding to a poor priority category, and a light shade corresponding to a neutral priority category.

More specifically, the column 856 corresponds to an account “Client A” with a net promoter score of +10 with ten respondents and includes a bar graph 862. The bar graph 862 utilizes shading to show different segments of a net promoter score that correspond to priority categories. As shown in FIG. 8C, the bar graph 862 shows 20% in a medium shade corresponding to a poor priority category, 50% in a light shade corresponding to a neutral priority category, and 30% in a dark shade corresponding to a positive priority category.

Additionally, the column 856 includes survey responses corresponding to the account, including freeform responses and a likelihood to recommend score. More specifically, the column 856 includes a decision maker category including the text “James G, LTR=0 ‘I don't have trust in sr. leadership,’” and “Steve S, LTR=7 ‘I have had good relations with everyone here on location.’” Further, the column 856 includes an influencer category including the text “Jen B, LTR=10 ‘XXX is very professional, with motivated mudloggers who go out of their way to learn and ensure data is complete and accurate,’” and “Nino S, LTR=8 ‘Prompt and effective customer service. Good technology.’”

Additionally, the net promoter account map 854 includes the column 858, which corresponds to an account “Client B” that has a net promoter score of −33 with three respondents and includes a bar graph 864. The bar graph 864 also utilizes shading to show different segments of a net promoter score that correspond to priority categories. As shown in FIG. 8C, the bar graph 864 includes 33% in a medium shade corresponding to a poor priority category and 67% in a light shade corresponding to a neutral priority category.

The column 856 also includes survey responses corresponding to the account that include freeform responses and a likelihood to recommend score. More specifically, the column 856 includes an influencer category including the text “Katie C, LTR=0,” “Todd M, LTR=7 ‘Fairly reliable equipment−fair on service,’” and “Emily J, LTR=7 “Responsiveness−especially within the last few months.”

The net promoter account map 854 also includes the column 860 corresponding to an account “Client C” with a net promoter score of +33 and three respondents. The column 860 also includes a bar graph 866, which also utilizes shading to show different segments of a net promoter score. To illustrate, the bar graph 866 includes 67% in a light shade corresponding to a neutral priority category and 33% in a dark shade corresponding to a positive priority category. The column 860 further includes an influencer category including the text “Stefano M, LTR=10 ‘Very high technical ability, quality work, good communication, reliable link to the field.’” Additionally, the column 860 includes an end user category including the text “Carl Y, LTR=8 “Tools working properly, people working professionally.’”

Though FIG. 8C illustrates an example net promoter account map 854, it will be appreciated that the account prioritization system 106 can generate a net promoter account map based on a variety of net promoter scores and/or survey data. More specifically, the account prioritization system 106 can generate various visualizations of an account prioritization score by segmenting component portions, similar to the bar graphs 862, 864, 866. The account prioritization system 106 can also identify important survey responses from various question types, and can categorize those survey responses for presentation in a net promoter account map. Accordingly, in one or more embodiments, the account prioritization system 106 generates a net promoter account map including various account prioritization score visualizations and other related information. Thus, the account prioritization system 106 provides a variety of information to quickly assess various accounts at a glance.

Turning to FIG. 8D, the account prioritization system 106 can also generate account prioritization score visualizations including risk and urgency assessments. FIG. 8D illustrates a computing device 880 presenting a graphical user interface 882 including a revenue at risk chart 884. More specifically, the revenue at risk chart 884 includes a total annual revenue graph 886 and an account annual revenue graph 888.

The total annual revenue graph 886 includes revenue across all managed accounts corresponding to priority categories. The account prioritization system 106 can generate the total annual revenue graph 886 to illustrate the relative scope of all priority categorizations across all managed accounts at a glance. To illustrate, the total annual revenue graph 886 includes 12 accounts totaling $24,704,004 in annual revenue in a dark shade corresponding to a positive priority category, nine accounts totaling $5,227,343 in annual revenue in a light shade corresponding to a neutral priority category, and eight accounts totaling $30,073,719 in a medium shade corresponding to a negative priority category.

Further, the revenue at risk chart 884 includes the account annual revenue graph 888. The account annual revenue graph 888 includes an annual revenue axis 890 and an account axis 892. The annual revenue axis 890 includes scales both for annual revenue and cumulative annual revenue. More specifically, the account annual revenue graph 888 includes bars corresponding to the annual revenue and a line chart corresponding to cumulative annual revenue. The account axis 892 includes bar categorizations corresponding for various accounts and a number of respondents corresponding to each bar.

The account prioritization system 106 can generate the total annual revenue graph 886 and/or the account annual revenue graph 888 based on a variety of accounts with a variety of priority categories, sizes, account prioritization scores, etc. Thus, the account prioritization system 106 can generate an account prioritization score visualization that shows, at a glance, the scale of various priority categorizations both for particular accounts and for the total of all accounts. Thus, the account prioritization system 106 can show both account health and the scope of that health in an account prioritization score visualization.

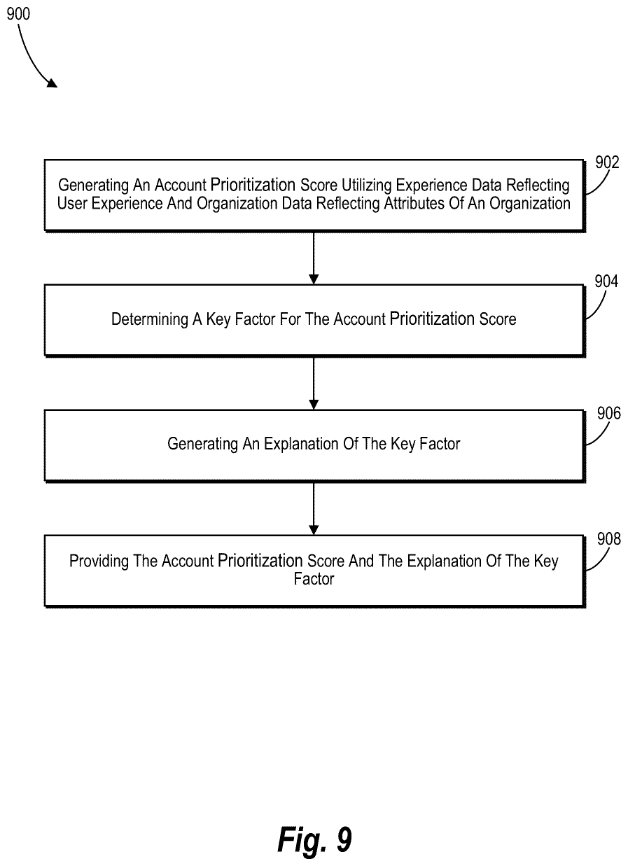

FIGS. 1-8D, the corresponding text, and the examples provide a number of different methods, systems, devices, and non-transitory computer-readable media of the account prioritization system 106. In addition to the foregoing, one or more embodiments can also be described in terms of flowcharts comprising acts for accomplishing a particular result, as shown in FIG. 9. FIG. 9 may be performed with more or fewer acts. Further, the acts may be performed in differing orders. Additionally, the acts described herein may be repeated or performed in parallel with one another or parallel with different instances of the same or similar acts.

As mentioned, FIG. 9 illustrates a flowchart of a series of acts 900 for generating an account prioritization score and a key factor for presentation in a graphical user interface in accordance with one or more embodiments. While FIG. 9 illustrates acts according to one embodiment, alternative embodiments may omit, add to, reorder, and/or modify any of the acts shown in FIG. 9. The acts of FIG. 9 can be performed as part of a method. Alternatively, a non-transitory computer-readable medium can comprise instructions that, when executed by one or more processors, cause a computing device to perform the acts of FIG. 9. In some embodiments, a system can perform the acts of FIG. 9.

As shown in FIG. 9, the series of acts 900 includes an act 902 for generating an account prioritization score utilizing experience data reflecting user experience and organization data reflecting attributes of an organization. In particular, the act 902 can include generating an account prioritization score for an account utilizing experience data reflecting user experience associated with the account and organization data reflecting attributes of an organization associated with the account. Specifically, the act 902 can include further comprising determining the account prioritization score by weighting the experience data and organization data.

Additionally, in one or more embodiments, the series of acts 900 includes an act 904 for determining a key factor for the account prioritization score. In particular, the act 904 can include determining a key factor for the account prioritization score from the experience data and the organization data. Specifically, the act 904 can include wherein the organization data comprises one or more of an account size, an operating margin for the account, an urgency score for the account, or operating metrics. Further, the act 904 can include wherein the experience data comprises one or more experience data metrics, which comprise one or more of a net promoter score for the account, a customer satisfaction score for the account, a customer experience score for the account, or a customer relationship management score for the account. Additionally, the act 904 can include wherein one or more of the experience data metrics are set or modified via an administrator device.

Further, the series of acts 900 can include an act 906 for generating an explanation of the key factor. Specifically, the act 906 can include further comprising determining the key factor by identifying a type of data that most contributes to a change in the account prioritization score. Additionally, the act 906 can include further comprising determining the key factor by identifying a type of data that most contributes to the account prioritization score. The act 906 can also include further comprising generating the explanation of the key factor to comprise an explanation of one or more goals set for the account.

Also, in some embodiments, the series of acts 900 includes an act 908 for providing the account prioritization score and the explanation of the key factor. In particular, the act 908 can include providing the account prioritization score and the explanation of the key factor via a graphical user interface. Specifically, the act 908 can include generating a visualization of the account prioritization score, and providing the visualization of the account prioritization score via the graphical user interface. Additionally, in one or more embodiments, the act 908 includes categorizing the account into a priority category based on the prioritization score, and providing an indication of the priority category via the graphical user interface.

Embodiments of the present disclosure can comprise or utilize a special purpose or general-purpose computer including computer hardware, such as, for example, one or more processors and system memory, as discussed in greater detail below. Embodiments within the scope of the present disclosure also include physical and other computer-readable media for carrying or storing computer-executable instructions and/or data structures. In particular, one or more of the processes described herein can be implemented at least in part as instructions embodied in a non-transitory computer-readable medium and executable by one or more computing devices (e.g., any of the media content access devices described herein). In general, a processor (e.g., a microprocessor) receives instructions, from a non-transitory computer-readable medium, (e.g., a memory, etc.), and executes those instructions, thereby performing one or more processes, including one or more of the processes described herein.

Computer-readable media can be any available media that can be accessed by a general purpose or special purpose computer system. Computer-readable media that store computer-executable instructions are non-transitory computer-readable storage media (devices). Computer-readable media that carry computer-executable instructions are transmission media. Thus, by way of example, and not limitation, embodiments of the disclosure can comprise at least two distinctly different kinds of computer-readable media: non-transitory computer-readable storage media (devices) and transmission media.

Non-transitory computer-readable storage media (devices) includes RAM, ROM, EEPROM, CD-ROM, solid state drives (“SSDs”) (e.g., based on RAM), Flash memory, phase-change memory (“PCM”), other types of memory, other optical disk storage, magnetic disk storage or other magnetic storage devices, or any other medium which can be used to store desired program code means in the form of computer-executable instructions or data structures and which can be accessed by a general purpose or special purpose computer.

A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmissions media can include a network and/or data links which can be used to carry desired program code means in the form of computer-executable instructions or data structures and which can be accessed by a general purpose or special purpose computer. Combinations of the above should also be included within the scope of computer-readable media.

Further, upon reaching various computer system components, program code means in the form of computer-executable instructions or data structures can be transferred automatically from transmission media to non-transitory computer-readable storage media (devices) (or vice versa). For example, computer-executable instructions or data structures received over a network or data link can be buffered in RAM within a network interface module (e.g., a “NIC”), and then eventually transferred to computer system RAM and/or to less volatile computer storage media (devices) at a computer system. Thus, it should be understood that non-transitory computer-readable storage media (devices) can be included in computer system components that also (or even primarily) utilize transmission media.

Computer-executable instructions comprise, for example, instructions and data which, when executed at a processor, cause a general-purpose computer, special purpose computer, or special purpose processing device to perform a certain function or group of functions. In some embodiments, computer-executable instructions are executed on a general-purpose computer to turn the general-purpose computer into a special purpose computer implementing elements of the disclosure. The computer executable instructions can be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the disclosure can be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, tablets, pagers, routers, switches, and the like. The disclosure can also be practiced in distributed system environments where local and remote computer systems, which are linked (either by hardwired data links, wireless data links, or by a combination of hardwired and wireless data links) through a network, both perform tasks. In a distributed system environment, program modules can be located in both local and remote memory storage devices.

Embodiments of the present disclosure can also be implemented in cloud computing environments. In this description, “cloud computing” is defined as a model for enabling on-demand network access to a shared pool of configurable computing resources. For example, cloud computing can be employed in the marketplace to offer ubiquitous and convenient on-demand access to the shared pool of configurable computing resources. The shared pool of configurable computing resources can be rapidly provisioned via virtualization and released with low management effort or service provider interaction, and then scaled accordingly.

A cloud-computing model can be composed of various characteristics such as, for example, on-demand self-service, broad network access, resource pooling, rapid elasticity, measured service, and so forth. A cloud-computing model can also expose various service models, such as, for example, Software as a Service (“SaaS”), Platform as a Service (“PaaS”), and Infrastructure as a Service (“IaaS”). A cloud-computing model can also be deployed using different deployment models such as private cloud, community cloud, public cloud, hybrid cloud, and so forth. In this description and in the claims, a “cloud-computing environment” is an environment in which cloud computing is employed.

FIG. 10 illustrates a block diagram of computing device 1000 that can be configured to perform one or more of the processes described above. One will appreciate that one or more computing devices such as the computing device 1000 can implement the various devices of the environment of FIG. 1. As shown by FIG. 10, the computing device 1000 can comprise a processor 1002, a memory 1004, a storage device 1006, an I/O interface 1008, and a communication interface 1010, which can be communicatively coupled by way of a communication infrastructure 1012. While an computing device 1000 is shown in FIG. 10, the components illustrated in FIG. 10 are not intended to be limiting. Additional or alternative components can be used in other embodiments. Furthermore, in certain embodiments, the computing device 1000 can include fewer components than those shown in FIG. 10. Components of the computing device 1000 shown in FIG. 10 will now be described in additional detail.

In one or more embodiments, the processor 1002 includes hardware for executing instructions, such as those making up a computer program. As an example, and not by way of limitation, to execute instructions, the processor 1002 can retrieve (or fetch) the instructions from an internal register, an internal cache, the memory 1004, or the storage device 1006 and decode and execute them. In one or more embodiments, the processor 1002 can include one or more internal caches for data, instructions, or addresses. As an example, and not by way of limitation, the processor 1002 can include one or more instruction caches, one or more data caches, and one or more translation lookaside buffers (TLBs). Instructions in the instruction caches can be copies of instructions in the memory 1004 or the storage device 1006.

The memory 1004 can be used for storing data, metadata, and programs for execution by the processor(s). The memory 1004 can include one or more of volatile and non-volatile memories, such as Random Access Memory (“RAM”), Read Only Memory (“ROM”), a solid state disk (“SSD”), Flash, Phase Change Memory (“PCM”), or other types of data storage. The memory 1004 can be internal or distributed memory.

The storage device 1006 includes storage for storing data or instructions. As an example, and not by way of limitation, storage device 1006 can comprise a non-transitory storage medium described above. The storage device 1006 can include a hard disk drive (HDD), a floppy disk drive, flash memory, an optical disc, a magneto-optical disc, magnetic tape, or a Universal Serial Bus (USB) drive or a combination of two or more of these. The storage device 1006 can include removable or non-removable (or fixed) media, where appropriate. The storage device 1006 can be internal or external to the computing device 1000. In one or more embodiments, the storage device 1006 is non-volatile, solid-state memory. In other embodiments, the storage device 1006 includes read-only memory (ROM). Where appropriate, this ROM can be mask programmed ROM, programmable ROM (PROM), erasable PROM (EPROM), electrically erasable PROM (EEPROM), electrically alterable ROM (EAROM), or flash memory or a combination of two or more of these.

The I/O interface 1008 allows a user to provide input to, receive output from, and otherwise transfer data to and receive data from computing device 1000. The I/O interface 1008 can include a mouse, a keypad or a keyboard, a touch screen, a camera, an optical scanner, network interface, modem, other known I/O devices or a combination of such I/O interfaces. The I/O interface 1008 can include one or more devices for presenting output to a user, including, but not limited to, a graphics engine, a display (e.g., a display screen), one or more output drivers (e.g., display drivers), one or more audio speakers, and one or more audio drivers. In certain embodiments, the I/O interface 1008 is configured to provide graphical data to a display for presentation to a user. The graphical data can be representative of one or more graphical user interfaces and/or any other graphical content as can serve a particular implementation.

The communication interface 1010 can include hardware, software, or both. In any event, the communication interface 1010 can provide one or more interfaces for communication (such as, for example, packet-based communication) between the computing device 1000 and one or more other computing devices or networks. As an example and not by way of limitation, the communication interface 1010 can include a network interface controller (NIC) or network adapter for communicating with an Ethernet or other wire-based network or a wireless NIC (WNIC) or wireless adapter for communicating with a wireless network, such as a WI-FI.

Additionally, or alternatively, the communication interface 1010 can facilitate communications with an ad hoc network, a personal area network (PAN), a local area network (LAN), a wide area network (WAN), a metropolitan area network (MAN), or one or more portions of the Internet or a combination of two or more of these. One or more portions of one or more of these networks can be wired or wireless. As an example, the communication interface 1010 can facilitate communications with a wireless PAN (WPAN) (such as, for example, a BLUETOOTH WPAN), a WI-FI network, a WI-MAX network, a cellular telephone network (such as, for example, a Global System for Mobile Communications (GSM) network), or other suitable wireless network or a combination thereof.

Additionally, the communication interface 1010 can facilitate communications various communication protocols. Examples of communication protocols that can be used include, but are not limited to, data transmission media, communications devices, Transmission Control Protocol (“TCP”), Internet Protocol (“IP”), File Transfer Protocol (“FTP”), Telnet, Hypertext Transfer Protocol (“HTTP”), Hypertext Transfer Protocol Secure (“HTTPS”), Session Initiation Protocol (“SIP”), Simple Object Access Protocol (“SOAP”), Extensible Mark-up Language (“XML”) and variations thereof, Simple Mail Transfer Protocol (“SMTP”), Real-Time Transport Protocol (“RTP”), User Datagram Protocol (“UDP”), Global System for Mobile Communications (“GSM”) technologies, Code Division Multiple Access (“CDMA”) technologies, Time Division Multiple Access (“TDMA”) technologies, Short Message Service (“SMS”), Multimedia Message Service (“MIMS”), radio frequency (“RF”) signaling technologies, Long Term Evolution (“LTE”) technologies, wireless communication technologies, in-band and out-of-band signaling technologies, and other suitable communications networks and technologies.

The communication infrastructure 1012 can include hardware, software, or both that couples components of the computing device 1000 to each other. As an example and not by way of limitation, the communication infrastructure 1012 can include an Accelerated Graphics Port (AGP) or other graphics bus, an Enhanced Industry Standard Architecture (EISA) bus, a front-side bus (FSB), a HYPERTRANSPORT (HT) interconnect, an Industry Standard Architecture (ISA) bus, an INFINIBAND interconnect, a low-pin-count (LPC) bus, a memory bus, a Micro Channel Architecture (MCA) bus, a Peripheral Component Interconnect (PCI) bus, a PCI-Express (PCIe) bus, a serial advanced technology attachment (SATA) bus, a Video Electronics Standards Association local (VLB) bus, or another suitable bus or a combination thereof.

FIG. 11 illustrates an example network environment 1100. Network environment 1100 includes a client system 1108, and a digital content survey system 1104 connected to each other by a network 1106. Although FIG. 11 illustrates a particular arrangement of client system 1108, digital content survey system 1104, and network 1106, this disclosure contemplates any suitable arrangement of client system 1108, digital content survey system 1104, and network 1106. As an example and not by way of limitation, two or more of client system 1108, and digital content survey system 1104 can be connected to each other directly, bypassing network 1106. As another example, two or more of client system 1108 and digital content survey system 1104 can be physically or logically co-located with each other in whole, or in part. Moreover, although FIG. 11 illustrates a particular number of client systems 1108, digital content survey system 1104, and network 1106, this disclosure contemplates any suitable number of client systems 1108, digital content survey system 1104, and network 1106. As an example and not by way of limitation, network environment 1100 can include multiple client systems 1108, digital content survey system 1104, and network 1106.

This disclosure contemplates any suitable network 1106. As an example and not by way of limitation, one or more portions of network 1106 can include an ad hoc network, an intranet, an extranet, a virtual private network (VPN), a local area network (LAN), a wireless LAN (WLAN), a wide area network (WAN), a wireless WAN (WWAN), a metropolitan area network (MAN), a portion of the Internet, a portion of the Public Switched Telephone Network (PSTN), a cellular telephone network, or a combination of two or more of these. Network 1106 can include one or more networks.

Links can connect client system 1108, and digital content survey system 1104 to network 1106 or to each other. This disclosure contemplates any suitable links. In particular embodiments, one or more links include one or more wireline (such as for example Digital Subscriber Line (DSL) or Data Over Cable Service Interface Specification (DOCSIS)), wireless (such as for example Wi-Fi or Worldwide Interoperability for Microwave Access (WiMAX)), or optical (such as for example Synchronous Optical Network (SONET) or Synchronous Digital Hierarchy (SDH)) links. In particular embodiments, one or more links each include an ad hoc network, an intranet, an extranet, a VPN, a LAN, a WLAN, a WAN, a WWAN, a MAN, a portion of the Internet, a portion of the PSTN, a cellular technology-based network, a satellite communications technology-based network, another link, or a combination of two or more such links. Links need not necessarily be the same throughout network environment 1100. One or more first links can differ in one or more respects from one or more second links.

In particular embodiments, client system 1108 can be an electronic device including hardware, software, or embedded logic components or a combination of two or more such components and capable of carrying out the appropriate functionalities implemented or supported by client system 1108. As an example and not by way of limitation, a client system 1108 can include any of the computing devices discussed above in relation to FIG. 11. A client system 1108 can enable a network user at client system 1108 to access network 1106. A client system 1108 can enable its user to communicate with other users at other client devices or systems.

In particular embodiments, client system 1108 can include a web browser, such as MICROSOFT EDGE, GOOGLE CHROME, or MOZILLA FIREFOX, and can have one or more add-ons, plug-ins, or other extensions, such as TOOLBAR or YAHOO TOOLBAR. A user at client system 1108 can enter a Uniform Resource Locator (URL) or other address directing the web browser to a particular server (such as server, or a server associated with a third-party system), and the web browser can generate a Hyper Text Transfer Protocol (HTTP) request and communicate the HTTP request to server. The server can accept the HTTP request and communicate to client system 1108 one or more Hyper Text Markup Language (HTML) files responsive to the HTTP request. Client system 1108 can render a webpage based on the HTML files from the server for presentation to the user. This disclosure contemplates any suitable webpage files. As an example and not by way of limitation, webpages can render from HTML files, Extensible Hyper Text Markup Language (XHTML) files, or Extensible Markup Language (XML) files, according to particular needs. Such pages can also execute scripts such as, for example and without limitation, those written in JAVASCRIPT, JAVA, MICROSOFT SILVERLIGHT, combinations of markup language and scripts such as AJAX (Asynchronous JAVASCRIPT and XML), and the like. Herein, reference to a webpage encompasses one or more corresponding webpage files (which a browser can use to render the webpage) and vice versa, where appropriate.

In particular embodiments, digital content survey system 1104 can include a variety of servers, sub-systems, programs, modules, logs, and data stores. In particular embodiments, digital content survey system 1104 can include one or more of the following: a web server, action logger, API-request server, relevance-and-ranking engine, content-object classifier, notification controller, action log, third-party-content-object-exposure log, inference module, authorization/privacy server, search module, advertisement-targeting module, user-interface module, user-profile store, connection store, third-party content store, or location store. Digital content survey system 1104 can also include suitable components such as network interfaces, security mechanisms, load balancers, failover servers, management-and-network-operations consoles, other suitable components, or any suitable combination thereof.

In particular embodiments, digital content survey system 1104 can include one or more user-profile stores for storing user profiles. A user profile can include, for example, biographic information, demographic information, behavioral information, social information, or other types of descriptive information, such as work experience, educational history, hobbies or preferences, interests, affinities, or location. Interest information can include interests related to one or more categories. Categories can be general or specific.

The foregoing specification is described with reference to specific exemplary embodiments thereof. Various embodiments and aspects of the disclosure are described with reference to details discussed herein, and the accompanying drawings illustrate the various embodiments. The description above and drawings are illustrative and are not to be construed as limiting. Numerous specific details are described to provide a thorough understanding of various embodiments.

The additional or alternative embodiments can be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes that come within the meaning and range of equivalency of the claims are to be embraced within their scope.

What is claimed is:

1. A computer-implemented method comprising:
generating an account prioritization score corresponding to an account utilizing experience data associated with the account and organization data associated with the account;
determining a key factor for the account prioritization score from the experience data and the organization data;
generating an explanation of the key factor; and
providing the account prioritization score and the explanation of the key factor via a graphical user interface.

2. The computer-implemented method as recited in claim 1, further comprising:
generating a visualization of the account prioritization score; and
providing the visualization of the account prioritization score via the graphical user interface.

3. The computer-implemented method as recited in claim 1, further comprising:
categorizing the account into a priority category based on the prioritization score; and
providing an indication of the priority category via the graphical user interface.

4. The computer-implemented method as recited in claim 1, wherein the organization data comprises one or more of an account size, an operating margin for the account, an urgency score for the account, or operating metrics.

5. The computer-implemented method as recited in claim 1, wherein the experience data comprises one or more experience data metrics, which comprise one or more of a net promoter score for the account, a customer satisfaction score for the account, a customer experience score for the account, or a customer relationship management score for the account.

6. The computer-implemented method as recited in claim 5, wherein the one or more experience data metrics are set or modified via an administrator device.

7. The computer-implemented method as recited in claim 1, further comprising determining the account prioritization score by weighting the experience data and organization data.

8. The computer-implemented method as recited in claim 1, further comprising determining the key factor by identifying a type of data that most contributes to the account prioritization score.

9. The computer-implemented method as recited in claim 1, further comprising determining the key factor by identifying a type of data that most contributes to a change in the account prioritization score.

10. The computer-implemented method as recited in claim 1, further comprising generating the explanation of the key factor to comprise an explanation of one or more goals set for the account.

11. A non-transitory computer-readable medium storing instructions that, when executed by at least one processor, cause a computer device to:
generate an account prioritization score corresponding to an account utilizing experience data associated with the account and organization data associated with the account;
determine a key factor for the account prioritization score from the experience data and the organization data;
generate an explanation of the key factor; and
provide the account prioritization score and the explanation of the key factor via a graphical user interface.

12. The computer-readable medium of claim 11, further comprising instructions that, when executed by the at least one processor, cause the computer device to:
generate a visualization of the account prioritization score; and
provide the visualization of the account prioritization score via the graphical user interface.

13. The computer-readable medium of claim 11, wherein the organization data comprises one or more of an account size, an operating margin for the account, an urgency score for the account, or operating metrics.

14. The computer-readable medium of claim 11, wherein the experience data comprises one or more experience data metrics, which comprise one or more of a net promoter score for the account, a customer satisfaction score for the account, a customer experience score for the account, or a customer relationship management score for the account.

15. The computer-readable medium of claim 11, further comprising instructions that, when executed by the at least one processor, cause the computer device to determine the account prioritization score by weighting the experience data and organization data.

16. The computer-readable medium of claim 11, further comprising instructions that, when executed by the at least one processor, cause the computer device to determine the key factor by:
identifying a type of data that most contributes to the account prioritization score; or
identifying a type of data that most contributes to a change in the account prioritization score.

17. A system comprising:
at least one processor; and
at least one non-transitory computer-readable storage medium storing instructions that, when executed by the at least one processor, cause the system to:
generate an account prioritization score corresponding to an account utilizing experience data associated with the account and organization data associated with the account;
determine a key factor for the account prioritization score from the experience data and the organization data;
generate an explanation of the key factor; and
provide the account prioritization score and the explanation of the key factor via a graphical user interface.

18. The system of claim 17, further comprising instructions that, when executed by the at least one processor, cause the system to:
generate a visualization of the account prioritization score; and
provide the visualization of the account prioritization score via the graphical user interface.

19. The system of claim 17, wherein the organization data comprises one or more of an account size, an operating margin for the account, an urgency score for the account, or operating metrics.

20. The system of claim 17, wherein the experience data comprises one or more experience data metrics, which comprise one or more of a net promoter score for the account, a customer satisfaction score for the account, a customer experience score for the account, or a customer relationship management score for the account.
